(19) United States
(12) Patent Application Publication
(10) Pub. No.: US 2026/0264219 A1
(43) Pub. Date: Sep. 10, 2026

(54) HUMANOID ROBOT WITH WIRELESS DATA OFFLOAD CAPABILITY

(71) Applicant: Figure AI Inc., San Jose, CA (US)

(72) Inventors: Ryan Benyshek, San Jose, CA (US); Basel Zohny, San Jose, CA (US); Adeel Zaheer, San Jose, CA (US); Sydney Hardy, San Jose, CA (US)

(21) Appl. No.: 19/558,158

(22) Filed: Mar. 5, 2026

Related U.S. Application Data
(60) Provisional application No. 63/767,281, filed on Mar. 5, 2025.
(60) Provisional application No. 63/839,474, filed on Jul. 7, 2025.
(60) Provisional application No. 63/839,479, filed on Jul. 7, 2025.
(60) Provisional application No. 63/850,760, filed on Jul. 25, 2025.
(60) Provisional application No. 63/875,074, filed on Sep. 3, 2025.
(60) Provisional application No. 63/874,723, filed on Sep. 3, 2025.
(60) Provisional application No. 63/875,558, filed on Sep. 4, 2025.

(51) Int. Cl. B25J 9/00; B25J 13/00; B25J 19/02; G05D 1/661; G05D 109/12; G05D 111/10; G05D 111/30; H01Q 1/27; H01Q 21/06; H02J 50/10

(52) U.S. Cl. CPC B25J 9/0009; B25J 13/006; B25J 19/023; G05D 1/661; H01Q 1/27; H01Q 21/065; H02J 50/10; G05D 2109/12; G05D 2111/10; G05D 2111/32

(57) ABSTRACT

A humanoid robot includes a torso, a plurality of sensors configured to capture sensor data during operation, a battery pack, a data storage for storing the captured sensor data, and a communication transceiver module. The communication transceiver module includes at least one antenna array module having a plurality of antenna elements configured for millimeter-wave communication at frequencies above 40 GHz. The communication transceiver module establishes a short-range wireless data link with a corresponding transceiver module of an external docking station when positioned within a predefined separation gap, enabling data transfer at rates exceeding 5 gigabits per second. The humanoid robot further includes a wireless power receiver for charging the battery pack. The communication transceiver module is configured to offload all sensor data collected during an operational runtime in a data offload time period that is less than a charging time period required to recharge the battery pack.

### CROSS REFERENCE TO RELATED APPLICATION

This application claims the benefit and priority to U.S. Provisional Application Nos. 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is expressly incorporated by reference herein in its entirety.

### TECHNICAL FIELD

The present disclosure generally pertains to a robot with a wireless data offload capability. More specifically, a humanoid robot that is designed and configured to interact with a docking station in order to wirelessly offload data collected by the humanoid robot while it was operating in either an autonomous mode or an imitation mode.

### BACKGROUND

The current workplace landscape is marked by an unparalleled labor shortage, evident in over 10 million unsafe or undesirable jobs within the United States. To counter this ever-expanding labor shortage, it has become imperative to design and integrate advanced robots capable of handling unappealing and even hazardous workplace tasks. With the goal of performing these tasks in an optimal and efficient manner, advanced robots are typically general-purpose humanoid robots tailored for human-centric environments. To work in human-centric environments, the general-purpose humanoid robot may generate data during autonomous operation that needs to be transferred to other computing systems.

### SUMMARY

In one aspect, the present disclosure provides a humanoid robot comprising a torso, a compute housed within the torso and configured to control the operation of the humanoid robot, and a data storage communicatively coupled to the compute and configured to store data collected by the humanoid robot during operation. The humanoid robot further comprises a communication transceiver module communicatively coupled to the compute. The communication transceiver module includes a first antenna array module having a plurality of antenna elements configured for millimeter-wave communication and a second antenna array module having a plurality of antenna elements configured for millimeter-wave communication. The communication transceiver module is configured to establish a wireless data link with a corresponding communication transceiver module of an external device when the communication transceiver module and the corresponding communication transceiver module are positioned within a predefined separation gap. The wireless data link is configured to transfer data stored in the data storage to the external device at a data transfer rate exceeding 5 gigabits per second.

In some embodiments, the communication transceiver module is positioned within a waist of the humanoid robot. In some embodiments, the first antenna array module is configured with a transmit pair of antenna elements and a receive pair of antenna elements, and the second antenna array module is configured with a transmit pair of antenna elements and a receive pair of antenna elements. In some such embodiments, the first and second antenna array modules are arranged side by side on a printed circuit board, and each antenna array module comprises four antenna elements arranged in a two-by-two grid pattern.

In some embodiments, at least a portion of the humanoid robot is formed from an RF transparent material, and the communication transceiver module is positioned within the humanoid robot such that radio waves pass through the portion of the humanoid robot formed from the RF transparent material. In some embodiments, the predefined separation gap is between 5 mm and 50 mm. In some embodiments, the communication transceiver module is configured to perform electronic beam-steering to adjust directionality of transmitted signals to compensate for minor misalignments between the communication transceiver module and the corresponding communication transceiver module of the external device. In some embodiments, the humanoid robot further comprises a behavior manager configured to constrain the humanoid robot from initiating motion relative to the external device until the wireless data link completes a data transfer protocol or the data transfer protocol is terminated.

In another aspect, the present disclosure provides a humanoid robot comprising a torso, a waist coupled to the torso, a plurality of sensors configured to collect data during operation of the humanoid robot, and a data storage configured to store the data collected by the plurality of sensors. The humanoid robot further comprises a communication transceiver module coupled to the waist. The communication transceiver module comprises a plurality of antenna elements configured to emit signals at a frequency that is above 40 GHz and is configured to wirelessly offload data from the data storage to an external device when the humanoid robot is mechanically coupled to the external device.

In some embodiments, the plurality of sensors comprise one or more cameras configured to continuously capture video data during operation of the humanoid robot. In some embodiments, the communication transceiver module is coupled to the waist in a rear-facing orientation. In some embodiments, the humanoid robot is configured to receive a communication from the external device confirming successful mechanical coupling between the humanoid robot and the external device based on sensor data collected by one or more sensors of the external device, and based on receiving the communication from the external device, initiate the wireless offload of data via the communication transceiver module.

In some embodiments, the humanoid robot further comprises left and right feet configured to receive wireless power from a wireless power transfer system of the external device, and the humanoid robot is configured to simultaneously receive wireless power through the left and right feet and offload data through the communication transceiver module when mechanically coupled to the external device. In some embodiments, the data storage is configured to store data collected during an operational runtime period, and the communication transceiver module is configured to offload all data collected during the operational runtime period in a time period that is less than a time period required to fully charge a battery pack of the humanoid robot following the operational runtime period. In some embodiments, the humanoid robot further comprises a near-field communication transceiver configured to perform a secure handshake with the external device prior to initiating data transfer via the communication transceiver module.

In yet another aspect, the present disclosure provides a humanoid robot comprising a plurality of sensors configured to capture sensor data during an operational runtime of the humanoid robot, a battery pack configured to power the humanoid robot, a data storage configured to store the sensor data collected during the operational runtime, and a wireless power receiver configured to receive wireless power from a corresponding wireless power transmitter to charge the battery pack of the humanoid robot. The humanoid robot further comprises a communication transceiver module including at least one antenna array module having a plurality of antenna elements configured for high data rate millimeter-wave communication. The communication transceiver module is configured to establish a short-range wireless data link. Sensor data captured during a given operational runtime is offloadable via the wireless data link in a data offload time period, and the data offload time period is less than a charging time period required for the wireless power receiver to recharge an amount of energy discharged from the battery pack during the given operational runtime.

In some embodiments, the communication transceiver module operates at a frequency of approximately 60 GHz and provides a data transfer rate of at least 5 gigabits per second. In some embodiments, the communication transceiver module comprises a first antenna array module positioned within a first foot of the humanoid robot and a second antenna array module positioned within a second foot of the humanoid robot. In some embodiments, the humanoid robot further comprises a waist, the communication transceiver module is positioned within the waist, and a docking station comprises a support cradle configured to mechanically couple with the waist of the humanoid robot, the cradle including the corresponding communication transceiver module positioned to align with the communication transceiver module of the humanoid robot when the humanoid robot is docked with the docking station. In some embodiments, the humanoid robot is configured to receive a communication from the docking station confirming successful docking between the humanoid robot and the docking station based on sensor data collected by one or more sensors of the docking station, and based on receiving the communication from the docking station, initiate offload of the captured sensor data.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded, control and/or be controlled, and/or interact;

FIG. 2 is a block diagram illustrating components of the humanoid robot of FIG. 1;

FIG. 3 is a perspective view of a humanoid robot of FIGS. 1-2;

FIG. 4 is a block diagram of sensors for the humanoid robot of FIGS. 1-3;

FIG. 5 is a block diagram of a communication interface for the humanoid robot of FIGS. 1-3;

FIG. 6 is a block diagram of a wireless offload system using an example communication interface of FIG. 5, where the example communication interface is a communication transceiver module configured for high data rate delivery, and illustrating the arrangement for data communication between communication transceiver modules contained in the robot and an external device;

FIG. 7 is a perspective front view showing a docking station designed for the general-purpose humanoid robot of FIG. 3, where the docking station includes a support cradle with a communication transceiver module of FIG. 6;

FIG. 8 is an exploded side view of the support cradle of the docking station of FIG. 7, where the support cradle includes the communication transceiver module, a lower cradle shell, an upper cradle shell, a rear shell, a tail shell, vertical alignment posts, side gripper pads, and a rear support pad;

FIG. 9 is another exploded view of the support cradle of the docking station of FIG. 7;

FIG. 10 is an enlarged front perspective view of the support cradle of the docking station of FIG. 7, shown without the upper cradle shell to reveal the position of the communication transceiver module;

FIG. 11 is a front view of the support cradle of the docking station of FIG. 10;

FIG. 12 is a perspective view of the communication transceiver module housed within the support cradle of FIG. 10;

FIG. 13 is a front view of the communication transceiver module of FIG. 12;

FIG. 14 is a right side view of the humanoid robot of FIG. 3 and the docking station of FIG. 7 in a docked state;

FIG. 15 is an enlarged side view of the waist region of the humanoid robot and the docking station in the docked state of FIG. 14;

FIG. 16 is a rear view of the waist region of the humanoid robot and the docking station in the docked state of FIG. 14;

FIG. 17 is a perspective view of the interface region between the robot and the support cradle of the docking station, showing the respective wireless communication interfaces in operative, aligned positions;

FIG. 18 is a top view of the interface region of FIG. 17, showing the wireless communication transceivers in their operative positions;

FIG. 19 illustrates various alternative embodiments of the communication transceiver module of FIG. 6;

FIG. 20 illustrates an additional alternative embodiment of the communication transceiver module of FIG. 6;

FIG. 21 is a block diagram of a movement controller for the humanoid robot of FIGS. 1-3; and

FIG. 22 is a block diagram of a behavior manager for the humanoid robot of FIGS. 1-3.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The next generation of autonomous humanoid robots will walk factory floors, patrol warehouses, and navigate office corridors for hours at a stretch, collecting torrents of sensor data with every step. A single robot outfitted with high-resolution cameras, torque sensors, tactile arrays, and inertial measurement units can generate upwards of seventy-five gigabytes of data per hour-more than three hundred gigabytes during a typical four-hour shift. That data is the lifeblood of the cloud-based artificial intelligence systems that train, refine, and improve the robot's behavior over time. Yet getting that data off the robot and into the cloud remains one of the most stubborn engineering bottlenecks in the field. Existing wireless networks are simply not up to the task. A client's Wi-Fi network, even at its best near a 5 GHz access point, may deliver one to two gigabits per second under ideal conditions, but real-world congestion from other connected devices routinely drops throughput to a fraction of that figure. Cellular 5G connections fare little better, often falling below one hundred megabits per second through commercial carriers, and coverage varies wildly by location. Plugging in a cable solves the speed problem but creates a new one: it demands human intervention, undermining the very autonomy the robot is designed to deliver.

The invention disclosed here eliminates this bottleneck with a wireless data offload system that pairs a millimeter-wave communication transceiver inside the robot with a mirrored transceiver housed in a purpose-built docking station. Operating in the 60 GHz V-Band under IEEE 802.11ad and 802.11ay standards—commonly known as WiGig—the system achieves sustained, multi-gigabit data throughput across a contactless link that spans only a few centimeters of open air. At a sustained transfer rate of ten gigabits per second, the robot can offload an entire four-hour shift's worth of collected data in roughly five to fifteen minutes, a process that finishes long before the robot's battery completes its own recharge cycle. The key insight is that the docking station does double duty: it physically cradles the robot to recharge its battery through wireless power transfer coils in the base while simultaneously aligning the two transceivers with the precision that millimeter-wave communication demands. By converting what would otherwise be a difficult mobile-communications problem into a quasi-static one—where the transmitter and receiver are mechanically locked in place—the system sidesteps the severe path loss and oxygen absorption that plague 60 GHz signals over longer distances.

The architecture of the transceiver modules themselves reflects a deliberate pursuit of simplicity and resilience. Each module carries two antenna array boards arranged side by side, and each board contains four millimeter-wave transceivers paired with four antenna elements in a compact two-by-two grid. A Reduced Pin Extended Attachment Unit Interface splits a ten-gigabit data stream into two lanes running at 6.25 gigabits per second apiece, each carried over differential signal pairs that resist electromagnetic interference. The robot-side and station-side modules share an identical printed circuit board layout, a common bill of materials, and common firmware—a mirrored design that halves manufacturing complexity and simplifies field servicing. When the two modules face each other across the separation gap, transmit pairs on one side line up automatically with receive pairs on the other, establishing four independent lanes of communication. If one antenna array fails, the remaining array can still complete the transfer at a reduced rate, providing built-in redundancy without additional hardware.

Achieving the tight alignment that millimeter-wave links require is not left to chance; it is engineered into the physical shape of the docking station. The robot approaches the station and reverses into a support cradle whose inner surfaces are contoured to match the three-dimensional geometry of the robot's waist. As the robot settles into position, vertical alignment posts on the cradle engage with concave recesses machined into the robot's body, providing definitive mechanical registration in all three axes. This engagement corrects for lateral misalignments of up to fifteen millimeters, separation gaps from zero to twenty-five millimeters, and angular deviations of up to ten degrees. Once gross mechanical alignment is achieved, electronic beamforming and beam-steering algorithms take over, performing closed-loop fine adjustments guided by real-time monitoring of signal-to-noise ratio and bit error rate to maintain an optimal link throughout the entire data transfer session. The result is a multi-stage alignment protocol-coarse navigation, fine mechanical mating, and electronic micro-correction—that reliably produces a stable, high-quality channel without requiring any human involvement.

The rear-engagement design of the docking station represents a meaningful departure from conventional robot docking architectures. Traditional docking stations receive a robot head-on, an approach adequate for low-slung wheeled platforms but poorly suited to humanoid forms that carry a high center of gravity, concentrate sensors and manipulators on their front side, and must occupy the smallest possible floor footprint. By engaging the robot from behind at the waist, the docking station leaves every forward-facing sensor, camera, and communication array completely unobstructed. The robot can continue to monitor its surroundings, interact with people or objects in front of it, and communicate over conventional wireless networks even while securely docked. A cantilevered support cradle projecting forward from a vertical arm keeps the robot's center of mass positioned directly over the widest, most stable portion of the base, and a flared structural transition between the arm and the base distributes mechanical loads through a rigid triangulated geometry that resists tipping and rocking. The base itself features a low-profile platform-preferably less than two inches above the floor—with a beveled leading edge that the robot can step onto without altering its normal gait, reducing stress on ankle and foot actuators during the final approach.

Beyond the primary 60 GHz link, the system is designed with a broad menu of alternative and supplementary communication modalities that can be selected dynamically based on real-time environmental conditions. An onboard behavior manager evaluates factors such as spectral congestion, interference levels, data priority, and available power budget to choose among options that include other millimeter-wave bands at 28 or 70 GHz, terahertz frequencies capable of offloading terabytes in seconds, tri-band Wi-Fi spanning 2.4, 5, and 6 GHz, aggregated cellular and Wi-Fi links, and optical methods ranging from Li-Fi over modulated LED lighting to laser-based free-space links. Near-field communication can handle a secure initial handshake, exchanging cryptographic keys and data manifests before the high-power link activates. Inductive coupling can multiplex a data signal onto the same magnetic field used for wireless charging. Ultra-wideband ranging can guide centimeter-level docking alignment, and even acoustic data transmission using ultrasonic transceivers is contemplated for environments saturated with electromagnetic interference. This layered, multimodal approach ensures that the robot can offload its data reliably regardless of the RF environment it operates in.

The transceiver placement is not limited to the robot's waist. Alternative embodiments position the communication module in the torso, the head, the legs, or the feet, each paired with a corresponding offload device tailored to that body location. A torso-mounted transceiver can couple with a wall-mounted station or the backrest of a chair when the robot assumes a seated posture, conserving lower-limb actuator energy. A head-mounted module can use conformal antenna elements printed on a flexible substrate that follows the interior curvature of the head shell, pairing with a headrest-mounted receiver. Leg-mounted modules split the antenna arrays between the left and right shins and couple with a ground-level station whose arrays are spaced to match the robot's neutral standing stance. A foot-mounted configuration nests the antenna arrays inside the wireless charging coils themselves, so that centering the feet for power transfer simultaneously aligns the data link, with ferrite shielding isolating the two electromagnetic systems from each other. Each of these configurations preserves the core principle of the invention: mechanical docking enforces the precise, repeatable alignment that high-frequency, short-range wireless links require, transforming a volatile over-the-air channel into a deterministic, quasi-wired connection.

Artificial intelligence further sharpens the system's efficiency. The robot's onboard AI can perform data preprocessing and compression before transfer, employ federated learning techniques that distill raw sensor streams into compact model updates so that sensitive footage never leaves the device, and predict future data generation rates to schedule offloads proactively. Advanced error-correction protocols can reconstruct lost video packets from surrounding frames, reducing the need for retransmission. On the station side, the computing device can deduplicate, index, and pre-process the incoming data before forwarding it over a high-speed network backhaul to remote command centers or cloud-based training pipelines. The offloaded datasets themselves carry value well beyond machine learning: they include safety-critical logs of obstacle-avoidance decisions, raw protective-sensor readings suitable for offline forensic analysis under IEC 61508 functional safety standards, actuator temperature histories, battery cell voltage profiles, and bearing vibration spectra that feed predictive maintenance algorithms capable of flagging component degradation before a failure occurs. Taken together, these capabilities close the loop between field operation and continuous improvement, ensuring that every hour a humanoid robot spends at work feeds directly back into making the next hour more capable, more efficient, and safer.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

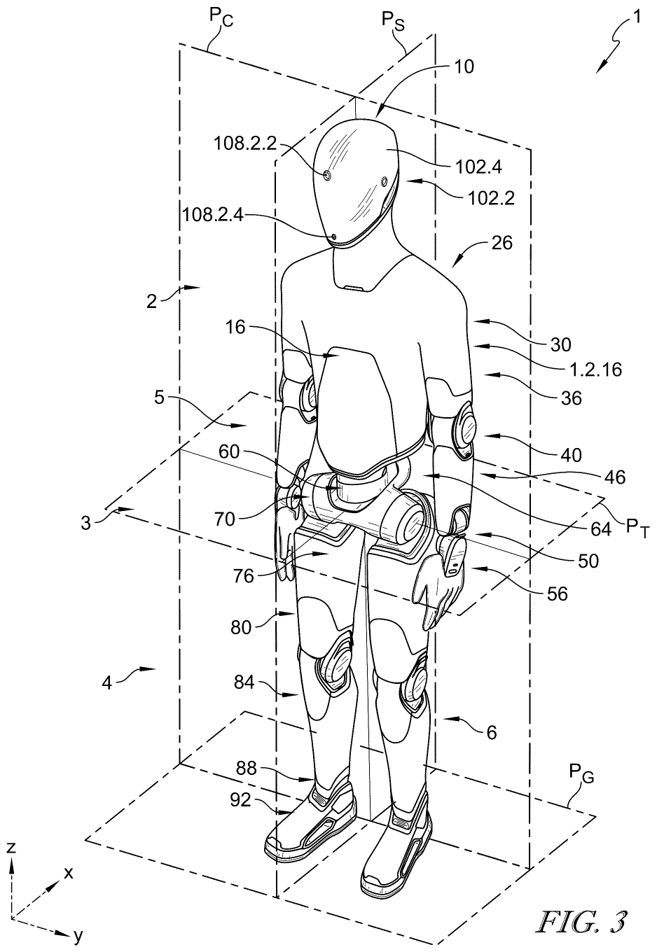

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 3A) is a vertical plane positioned at a midway point between the left and right legs and the left and right arms and contains a rotational axis A10 of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (Ps) is a plane that is colinear with the rotational axis A10 of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes A11 of the hip flex actuators (J11) located in the hips 70 (and likewise may contain an axis defined by a line connecting the midpoints of a left hip flex actuator (J11) axis (A11) and a right hip flex actuator (J11) axis (A11) and rotational axis A10 of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (PT) is a horizontal plane that contains the mid-point of the rotational axes A11 of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians. Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

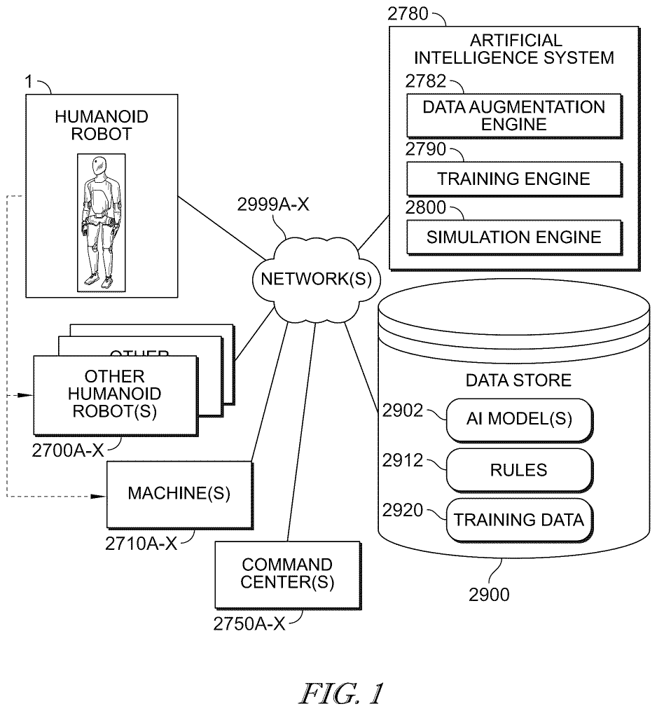

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may be the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-based AI system, and (vi) one or more data stores 2900. Each component may be interconnected with another component, directly or indirectly, by at least one of: (i) one or more networks 2999A-X, (ii) direct communication systems (e.g., a data store 2900 may have direct communication with a remote AI system 2780), and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in a jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals, and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first-person or third-person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical points and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

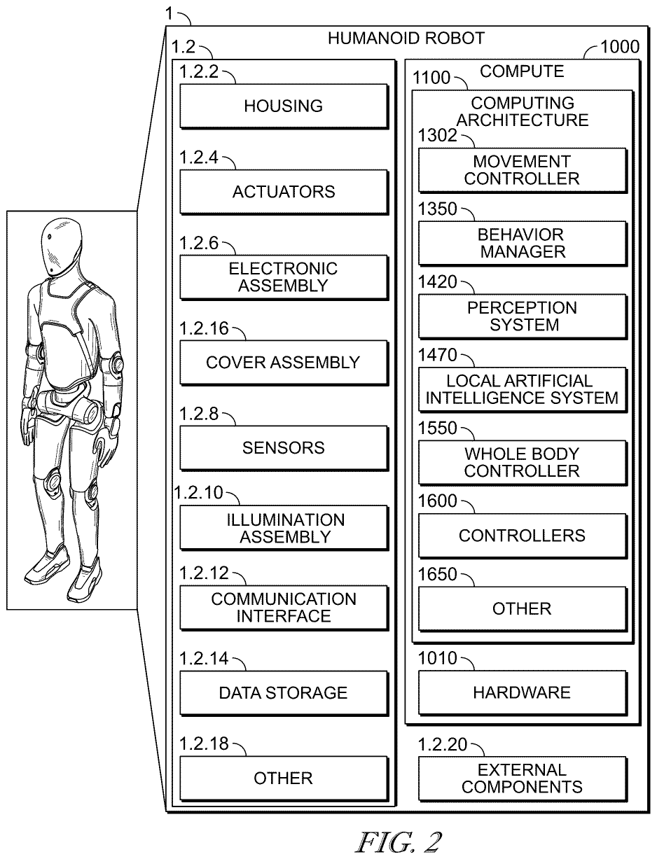

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (Ps) but is asymmetrical about Z-Y and X-Y planes that intersect the head and are parallel to the coronal plane (Pc) and the transverse plane (PT), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities, and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (Ps). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth), and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1} (a vertical yaw axis when the robot is in the neutral state) and a head nod actuator (J8.2) 140, which enables rotation of the head 10.1 about the axis A_{8.2} (a horizontal pitch axis when the robot is in the neutral state). Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. These head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack 202, the compute 1000 (which includes CPUs and GPUs), a power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack 202 and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Waist

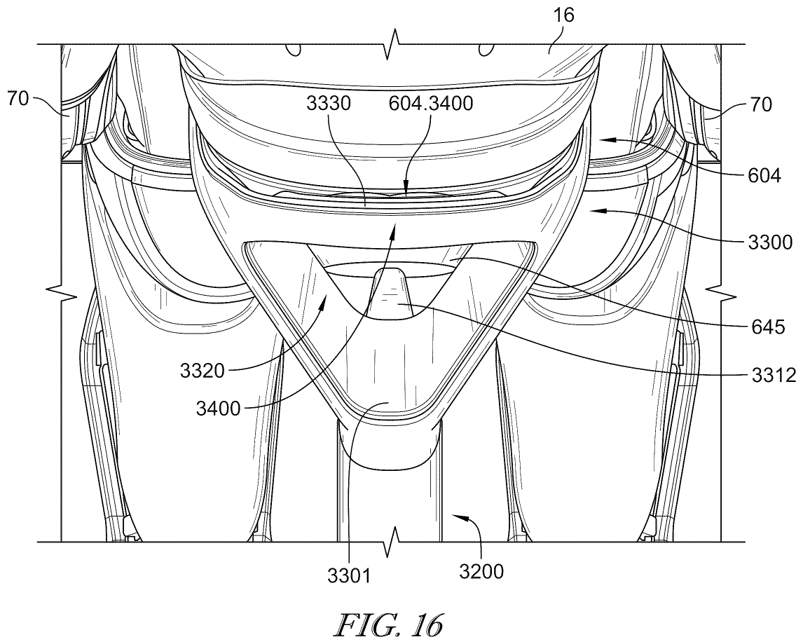

As best shown in FIGS. 3 and 14-16, the spine 60 of the robot 1 includes a waist 604 comprising: a waist body 604.2 shaped to enclose a lower extent of the torso 16 and contoured to transition the form of the robot 1 from the torso 16 to the pelvis 64. Specifically, said waist body 604.2 includes: (i) a main body 604.2.1 with a waist rim 604.2.2 and concave recesses 604.6.2 formed on the left and right sides adjacent to the rim 604.2.2, and (ii) a projecting actuator housing 604.2.4 that extends from the main body 604.2.1 and at least partially houses the torso twist actuator (J10) 620 that couples the torso 16 to the pelvis 64. In various embodiments, the waist body 604.2 also may include vent openings and/or perforated vent panels configured to allow passage of airflow to facilitate cooling within the torso 16.

In the illustrative embodiment, the waist 604 includes a communication transceiver module 604.3400 coupled within the waist body 604.2 in a rear position, where the communication transceiver module 604.3400 is communicatively coupled with the compute 1000 housed within the torso 16. In some embodiments, the communication transceiver module 604.3400 may be coupled within the torso 16, in a rear position near the waist 604. The waist body 604.2 and torso housing 162 provide adequate protection for the internally mounted antenna array without imposing a substantially negative effect on the RF transmissions. For example, the waist body 604.2 may be made from an RF transparent material (e.g., thermoplastics, fiberglass, polyethylene) that allows radio waves to pass through with minimal signal loss or attenuation.

Said main body 604.2.1 has a shallow parabolic shape. For example, the height of the main body 604.2.1 may be less than 13% of the width of the main body 604.2.1. This shallow main body 604.2.1 provides a curvilinear bottom shelf of the torso 16 that has a substantial area with a limited slope, which helps maximize the volume of the torso 16 and provides additional stability to the robot 1. The larger torso volume and additional stability is a substantial benefit over conventional robots that have a very narrow lower torso (e.g., a steep-sloped lower torso that has a width that is substantially equal to the width of the torso twist actuator). As shown in the figures, the projecting actuator housing 604.2.4 is not centered within the main body and instead is offset towards a forward-most extent of the torso 16. Further, the height of said projecting actuator housing 604.2.4 is configured to be sufficient to allow for enough clearance between the bottom extent of the main body 604.2.1 and the pelvis 64.

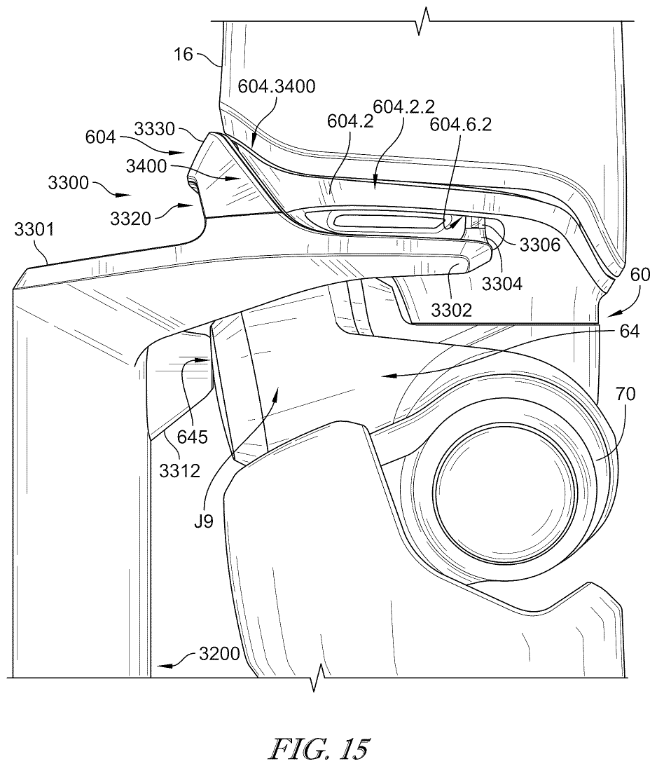

The waist body 604.2 is also capable of transferring at least a portion of the load the robot 1 undertakes while said robot is performing a task. Said transfer usually occurs from the arms 5, through the torso 16, and into the legs 6. As such, the waist body 604.2 includes a plurality of casing attachment supports that include additional thickness in the waist body 604.2 into the projecting actuator housing 604.2.4. Additionally, the robot 1 can be supported at each side at the waist 604. The waist body 604.2 may include cradle supports 604.6, each defined by concave recesses 604.6.2 at each side at the waist 604. The recesses 604.6.2 each provide a surface that can be grasped directly by human or robotic hands, and may include an aperture 604.6.4 configured to engage with a support structure. For example, as shown in FIG. 15, the concave recesses 604.6.2 may engage with the alignment posts 3306 of the illustrative docking station 3000.

### 4. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand 56 to the lower forearm 46. Furthermore, the wrist 50 may include a quick-release mechanism that enables the interchange of different end-effectors or tools. Moreover, the housing of each component may be designed with internal reinforcement structures and may be made from various materials (e.g., metal alloys or advanced materials like carbon-fiber-reinforced polymers).

### 5. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures and may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1-J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1-J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table.

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, lower humerus | A₄ |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, lower leg pitch, rear kick | A₁₄ |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about twenty-eight of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both hands 56 and to the foot flex actuators (J15) in each shin 84. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. Sensors

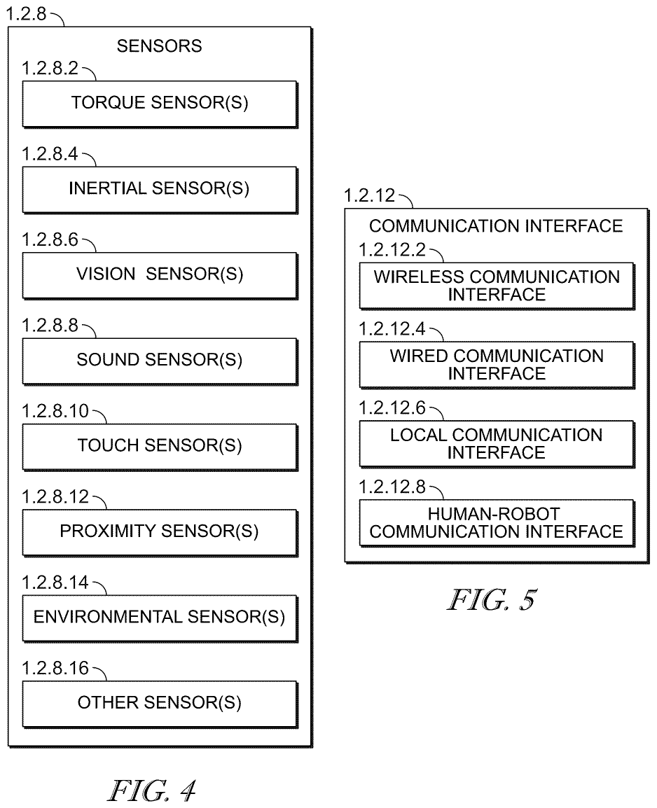

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, vision sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole-body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The vision sensors 1.2.8.6 may comprise sensors for capturing vision data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), and radar (e.g., to detect objects via radio waves and measure distance and speed for use in various applications including navigation and obstacle detection). Vision sensors 1.2.8.6 may also include event-based cameras, which report changes in pixel intensity rather than full frames, offering advantages in speed and data efficiency for dynamic scenes. Examples of said vision sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), and spatial audio sensors such as microphone arrays and direction-of-arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iii. Communication Interfaces

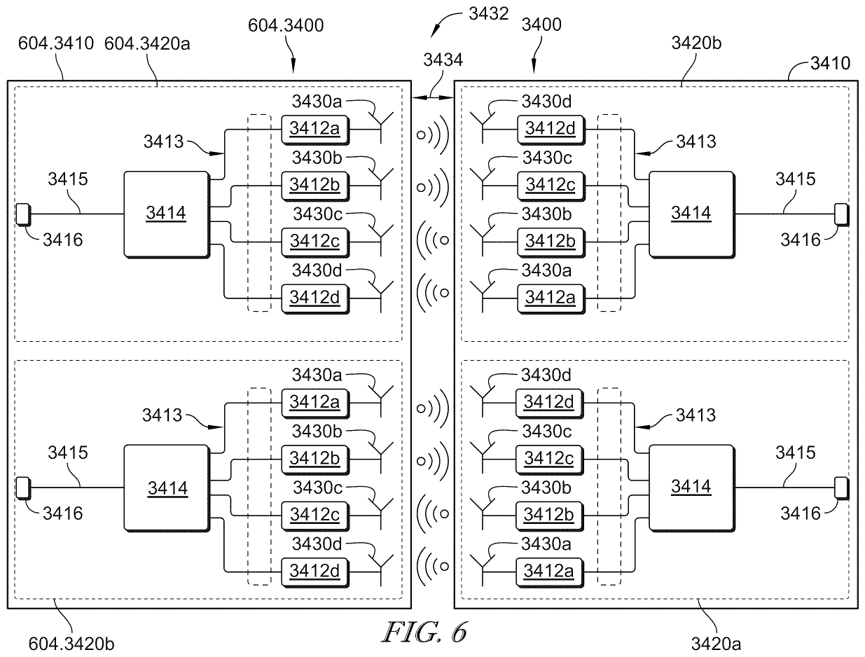

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to affect such communication.

Referring to FIG. 5, examples of communication interfaces 1.2.12 include a wireless communication interface 1.2.12.2 (e.g., Bluetooth®, Wi-FiR, WiMAX, Cellular (e.g., 3G, 4G, 5G), Zigbee, LoRa (Long Range), and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in boards, daughtercards, controller chips, chipsets, or other devices that may be used by the humanoid robot 1 for network communications with remote devices.

iv. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid-state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte-addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards, and communication interfaces of the storage devices that implement such standards may be referred to as DDR-based interfaces.

The memory device is a block-addressable memory device, such as those based on NAND or NOR technologies. A memory device may also include a three-dimensional crosspoint memory device (e.g., Intel® 3D XPoint® memory) or other byte addressable write-in-place non-volatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base, and the conductive bridge Random Access Memory (CB-RAM), or spin-transfer torque (STT)-MRAM, a spintronic magnetic junction memory-based device, a magnetic tunneling junction (MTJ) based device, a DW (Domain Wall) and SOT (Spin-Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

c. Compute

As illustrated in FIG. 2, the compute 1000 may comprise any combination of hardware, software, and circuitry to perform various computing functions that enable the humanoid robot 1 to operate semi- or fully autonomously. Specifically, the compute 1000 includes: (i) compute hardware 1010 and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management. The compute 1000 may further manage the scheduling and prioritization of concurrent computational tasks, allocating processing cycles among the various subsystems described herein according to the operational demands of the humanoid robot 1 at any given time.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1012 (e.g., x86 CPUs, ARM CPUs, RISC-V CPUs, embedded CPUs such as Internet-of-Things CPUs or mobile CPUs), graphics processing units (GPUS) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or another processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein. The compute hardware 1010 may further include dedicated hardware accelerators for inference workloads, cryptographic co-processors for securing data at rest and in transit, and direct memory access (DMA) controllers configured to facilitate high-throughput data movement between the processors and the data storage devices of the humanoid robot 1.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650. Each of these subcomponents may communicate with one or more of the other subcomponents via internal data buses, shared memory regions, or inter-process communication channels managed by the compute 1000. The computing architecture 1100 is structured such that any subcomponent may be implemented in hardware, software, firmware, or any combination thereof. In some embodiments, one or more of these subcomponents may be consolidated into a single integrated processing pipeline, while in other embodiments the subcomponents may be distributed across multiple discrete processing units within the compute hardware 1010.

### 1. Movement Controller

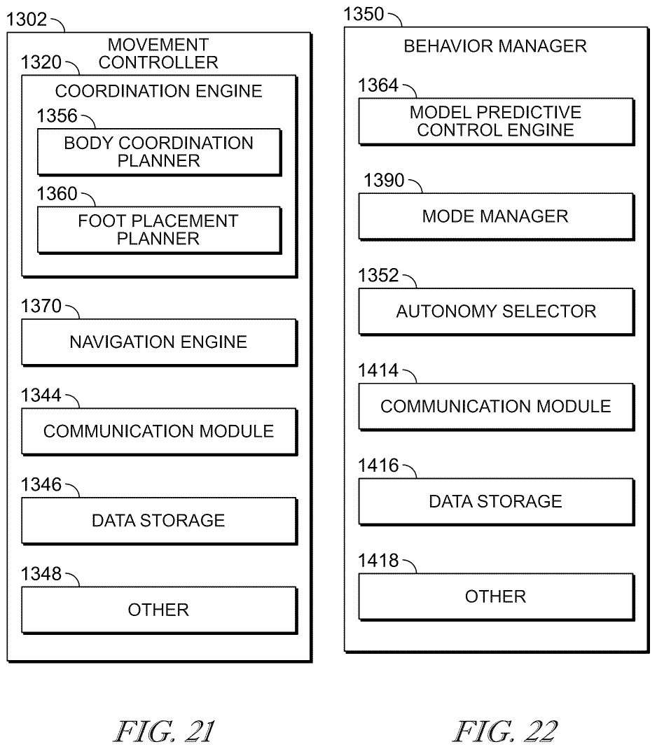

Referring to FIG. 21, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348. The movement controller 1302 may further include a trajectory validation module configured to verify that planned paths and action sequences comply with the kinematic and dynamic constraints of the humanoid robot 1 before execution commands are issued to the whole body controller 1550.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can address the issue of human-robot collaboration by incorporating models of human behavior and preferences into its decision-making process. This allows the robot 1 to generate plans that are not only efficient from a mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1. The navigation engine 1370 may further employ semantic mapping techniques to annotate the generated maps with contextual labels, such as room types, obstacle classifications, traversable surface types, and locations of docking stations 3000, thereby enriching the information available to the one or more AI systems 1470, 2780 for high-level task planning. In some embodiments, the navigation engine 1370 may maintain both a global map and a local map, where the local map represents the region in the immediate vicinity of the robot 1 and is updated at a higher frequency than the global map.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without utilizing processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 22, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints. The MPC engine 1364 may further incorporate cost functions that weight competing objectives, such as energy conservation, task completion speed, and mechanical wear reduction, in order to generate an optimal action policy for a given prediction horizon.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, a docking mode, and/or a data offload mode. Over time, the mode manager 1390 may collaborate with the local AI system 1470 to refine its mode selection based on learning algorithms. In some embodiments, the mode manager 1390 may be configured to manage transitions between modes according to a finite state machine, where each mode defines a set of permissible successor modes and a set of transition conditions that must be satisfied before the mode change is executed. The mode manager 1390 may further log each mode transition event along with a timestamp and a reason code for subsequent analysis by the local AI system 1470 or the remote AI system 2780.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to permit some form of manual input for operation. The autonomy selector 1352 may further support a graduated autonomy spectrum, allowing the operator to assign different autonomy levels to different subsystems of the humanoid robot 1 at the same time. For instance, locomotion may be set to fully autonomous while manipulation tasks are set to semi-autonomous or teleoperated.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. The perception system 1420 may further include a sensor fusion module configured to temporally and spatially align data streams from heterogeneous sensor modalities, including but not limited to visual, auditory, tactile, and inertial sensors, to produce a unified environmental representation. It should be understood that the perception system 1420 may be omitted and/or folded into the local AI system 1470.

4. Local AI system

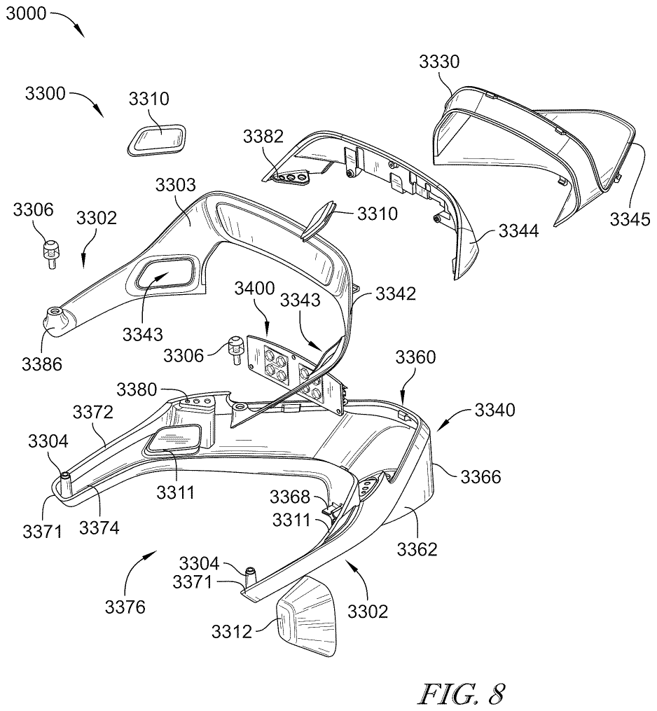

The local AI system 1470 may be embodied as any combination of hardware, software, or circuitry to drive semi to fully-autonomous perception, learning, and behavior by the humanoid robot 1. The local AI system 1470 may: (i) include models or architectures that are run on the disclosed local AI system 1470 only, (ii) include models or architectures where a portion of the model or architecture is run on the local AI system 1470 and another portion of the model or architecture is run on the remote AI system 2780, and (iii) include models or architectures that are run on the disclosed remote AI system 2780 only. The local AI system 1470 may further implement dynamic model partitioning, in which the division of computational work between the local AI system 1470 and the remote AI system 2780 is adjusted based on factors such as network latency, available local compute resources, and the time-sensitivity of the task at hand. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or may include the local AI system 1470 as a principal component. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time. The rule and policy selector 1508 may further resolve conflicts between concurrently active rules and policies 1484 by applying a priority hierarchy, where safety-related rules take precedence over operational efficiency rules, and regulatory compliance rules take precedence over both. In some embodiments, the rule and policy selector 1508 may generate an audit log recording each rule and policy selection event, along with the contextual factors that influenced the selection, for later review by an operator or compliance officer.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The language processing engine 1540 may further support multi-language processing, intent recognition, and contextual dialogue management, enabling the humanoid robot 1 to engage in multi-turn conversational interactions with human collaborators. The image processing engine 1542 may be embodied as any combination of hardware, software, or circuitry for performing object detection, image classification, segmentation, object tracking, facial recognition, scene understanding, depth estimation, anomaly detection, or reinforcement learning on input vision data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). The other 1546 may further include diagnostic interfaces, performance monitoring counters, and watchdog timers configured to detect and report anomalous processing conditions within the local AI system 1470. It should be understood that the controllers may be omitted and/or consumed by one or more models (e.g., RL trained models) that are contained within the local AI system 1470. In some embodiments, the other 1546 may include a secure enclave or trusted execution environment for protecting sensitive model parameters and cryptographic keys from unauthorized access.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not fall within the aforementioned mechanical and electrical architecture 1.2, or compute 1000. For example, the other components 1.2.18 may include safety systems and mechanisms, emergency override systems, or ports for connecting peripheral devices. In some embodiments, the other components 1650 may further include thermal management controllers configured to regulate processor temperatures during sustained high-compute workloads, and data integrity modules configured to perform periodic checksums on stored data to detect and correct bit-level errors.

d. High Volume Data Transfer

In various scenarios, the robot 1 may collect a large amount of data via sensors 1.2.8 while performing tasks and/or during a work period in an operational environment. In some cases, the robot 1 may include a data port for direct data transfer over a wired connection. However, this may be a less desirable option if human intervention is needed to establish the connection. Although the robot 1 may be connected to multiuse wireless networks (e.g., Wi-Fi® or Cellular) in the operational environment, the transmittal of data may be limited by the network availability and speed. For this reason, it may be inefficient to transmit data to a command center 2750A-X in real-time while the robot 1 is executing tasks.

For example, when utilizing the client Wi-Fi® network in the operational environment, at high bands (5-6 GHZ) and close to access points, the data transfer speed may be as high as 1-2 Gbps, but may be lower based on the number of other connected devices (e.g., more likely 100-500 Mbps), and is further limited by the client's connectivity to other networks and ability to upload. In some scenarios, robot connection to the client Wi-Fi® network may not be allowed due to security policies, bandwidth constraints, or administrative restrictions. In another example, when using 5G cellular connectivity, a local hot-spot may provide up to ~500 Mbps, where the speed is generally lower if using carriers (e.g., <100 Mbps) with coverage depending on location. The variability and potential congestion of these shared wireless networks make them unsuitable as the sole means of transferring the large volumes of sensor data that the humanoid robot 1 may accumulate during extended autonomous operational cycles.

To overcome these limitations, the illustrative robot 1 is configured for a wireless data offload system to establish a short range 60 GHz link between a communication transceiver module 604.3400 housed in the robot 1 and a communication transceiver module 3400 contained in an external component 1.2.20 coupled to a data store 2900. In the illustrative embodiment, a docking station 3000 includes the communication transceiver module 3400 arranged to communicatively couple with the communication transceiver module 604.3400 housed in the waist 604 of the robot 1. The robot 1 may operate autonomously without communicating with other devices and collect a large amount of data via various sensors 1.2.8 that is stored locally in the data storage 1.2.14 of the robot 1. The data stored in data storage 1.2.14 may include raw sensor streams, processed intermediate representations, event logs, diagnostic telemetry, and any other data generated by the subsystems of the robot 1 during its operational runtime.

i. High Data-Rate Communications

The communication interfaces 1.2.12 of the robot 1 may also include a communication transceiver module 604.3400 (e.g., a first communication transceiver module) contained in the robot 1 and configured to establish high-speed, short-range contactless communication with a communication transceiver module 3400 (e.g., a second communication transceiver module) contained in an external component 1.2.20. For example, the external component 1.2.20 may be a docking station, charging station, chair, wall mounted device, or portable device. The external component 1.2.20 may be further in data communication with a data store 2900 and/or one or more networks 2999A-X. In particular, the communication transceiver modules 604.3400, 3400 are configured for multi-gigabit data throughput using millimeter-wave radio frequency (mmWave) operating in a 60 GHz V-Band via IEEE 802.11ad and 802.11ay standards (WiGig).

As best illustrated in FIG. 6, communication transceiver modules 3400, 604.3400 are designed to be substantially identical, thereby forming a mirrored pair in order to establish the wireless bridge when within a predefined separation gap 3434 (e.g., separation distance or air gap). As such, the description herein regarding communication transceiver module 604.3400 applies equally to communication transceiver module 3400. The communication transceiver module 604.3400 includes first and second antenna array modules 604.3420a, 604.3420b. Similarly, communication transceiver module 3400 includes first and second antenna array modules 3420a, 3420b. The mirrored configuration of the communication transceiver modules 604.3400, 3400 reduces manufacturing complexity by permitting the use of a common printed circuit board layout, a common bill of materials, and common firmware for both the robot-side and station-side modules.

Each antenna array module 3420 (including 604.3420a, 604.3420b, 3420a, 3420b) includes a data interface 3416, a Reduced Pin eXtended Attachment Unit Interface (RXAUI) 3414, four millimeter-wave (mmWave) transceivers 3412, and four antenna elements 3430. For example, the data interface 3416 may be configured for data communication with the local computing device (e.g., compute 1000 of the robot 1 or station computing device 4350 of the docking station 3000) to deliver a 10 Gbps data stream 3415 to the RXAUI 3414. The RXAUI 3414 is configured to convert the data stream 3415 to two 6.25 Gbps lanes, where each lane (e.g., transmit and receive) is configured to deliver data over a differential pair using complementary signals, creating high-speed, noise-immune, and EMI-resistant data links (e.g., four signal paths 3413). The four mmWave transceivers 3412 (shown as 3412a-3412d) are configured to deliver the data via the four antenna elements 3430 (shown as 3430a-3430d). In some cases, the four antenna elements 3430 may be integrated with the individual mm Wave transceivers 3412. In other cases, the four antenna elements 3430 may be microstrip patch antennas that are formed on the substrate of the antenna array module 3420. Providing two antenna array modules 3420 on each of the communication transceiver modules 3400, 604.3400 increases the data throughput and provides for redundancy, such that if one of the antenna array modules 3420 is not operable (for either communication transceiver modules 3400, 604.3400), data may be downloaded at a lower rate using the operable array module 3420.

As shown in FIG. 6, each antenna array module 3420 (including 604.3420a, 604.3420b, 3420a, 3420b) may be substantially similar electrically for data delivery, which simplifies the design and minimizes the number of parts. For each antenna array module 3420, the individual mm Wave transceivers 3412a-3412d (e.g., STMicroelectronics ST60 series) are configured for low latency and high data rates and may be individually configured for transmit (Tx) or receive (Rx). In this illustrative example, the transceivers 3412a and 3412b are configured as a transmit pair (lane 1) and transceivers 3412c and 3412d are configured as a receive pair (lane 2). For example, the first communication transceiver module 604.3400 (housed in the robot 1) may include a substrate or PCB 604.3410 onto which antenna array modules 604.3420a, 604.3420b are arranged side by side. Similarly, the second communication transceiver module 3400 (housed in the docking station) may include a substrate or PCB 3410 onto which antenna array modules 3420a, 3420b are arranged side by side. As such, when the antenna elements 3430 of the first and second communication transceiver modules 604.3400, 3400 are arranged facing each other, the transmit pairs 3412a, 3412b are facing the receive pairs 3412d, 3412c for four lanes of data communication. In some embodiments, the Tx/Rx assignment of individual mmWave transceivers 3412 may be reconfigurable via firmware, allowing the communication transceiver modules 604.3400, 3400 to adapt their lane configurations to accommodate link asymmetry or to compensate for a degraded transceiver by redistributing the data load across the remaining operational transceivers.

To establish the communication link and minimize errors and/or data loss, the communication transceiver modules 604.3400, 3400 are configured to be in a face-to-face arrangement, separated by only a small or minimal separation gap 3434 (e.g., less than each of the following 5 mm, 1 cm, 2 cm, or 5 cm). The system is designed to be robust enough to maintain this link despite potential minor misalignments, for example, of up to +/−15 mm in the Z and Y directions, a separation gap 3434 of 0 to 25 mm, and an angular misalignment of up to +/−10 degrees. Electronic beamforming and beam-steering may be used to perform fine-scale adjustments to the directionality of the transmitted or received signal, thereby significantly enhancing the performance of the communication link after the initial mechanical docking has been achieved. In some embodiments, the beamforming algorithms may operate in a closed-loop manner, continuously monitoring received signal quality indicators such as signal-to-noise ratio (SNR) and bit error rate (BER), and iteratively adjusting beam weights to maintain an optimal link throughout the duration of the data offload session.

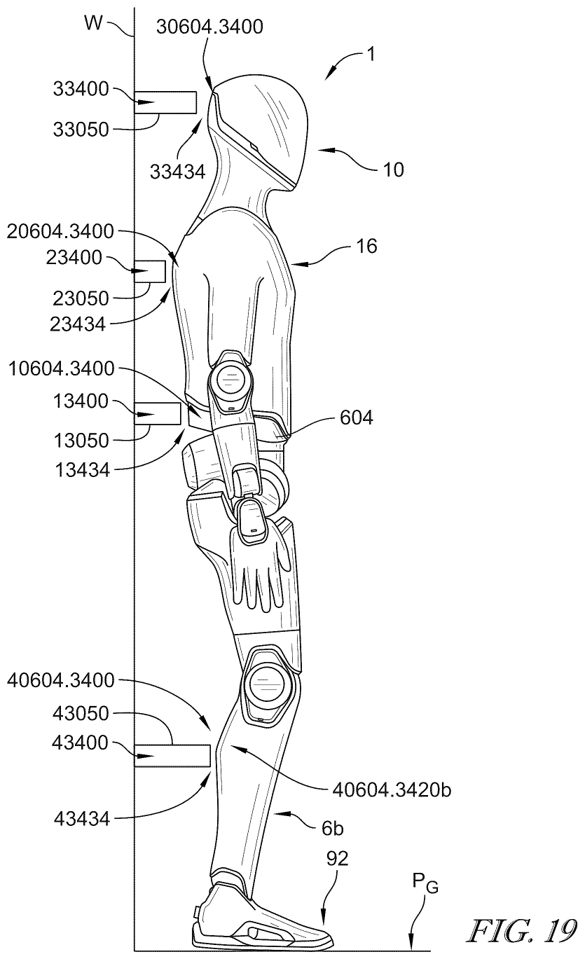

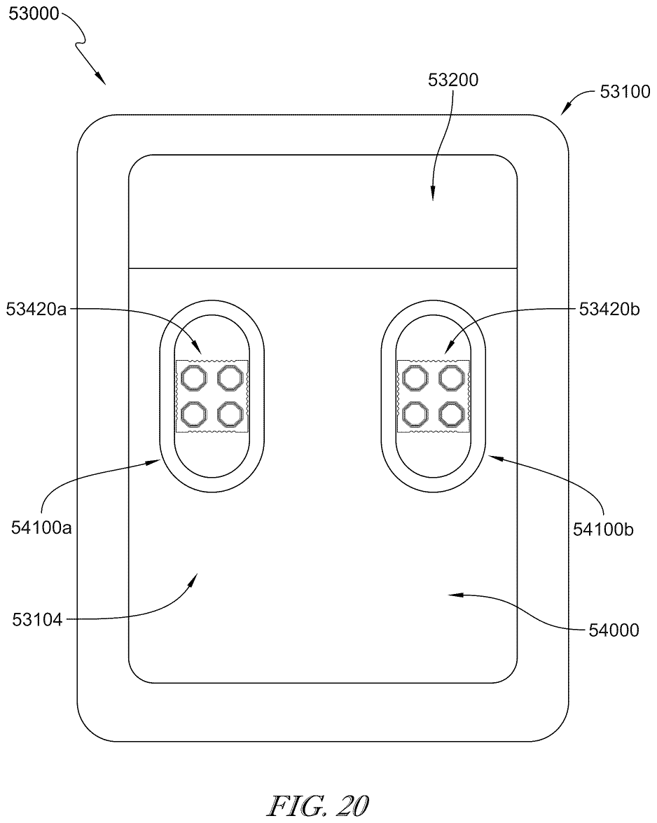

In the illustrative embodiment, the communication transceiver module 604.3400 is arranged in the rear of the waist 604 and configured to couple with a docking station 3000 with a communication transceiver module 3400 positioned in the support cradle 3300 to establish a wireless link as described herein. The illustrative docking station 3000 is configured to mechanically couple with the robot 1 from the rear, such that the communication transceiver modules 604.3400, 3400 are arranged facing each other, properly aligned, and spaced with an acceptable separation gap 3434 between antenna elements 3430 associated with the transmit pairs 3412a, 3412b facing the receive pairs 3412d, 3412c on opposed communication transceiver modules 604.3400, 3400. In alternative embodiments, the communication transceiver module 604.3400 may be positioned within a different component of the robot 1 and/or wirelessly coupled with a different external component 1.2.20 that contains a communication transceiver module 3400. For example, the different component of the robot 1 may include the torso 16, the head 10, the legs 6, or the feet 92, as further described herein with reference to FIGS. 19-20.

ii. Alternative Communication Modalities and Protocols

In some embodiments, the wireless communication system may be configured to operate using a plurality of communication modalities beyond the disclosed 60 GHz system. It is contemplated that the humanoid robot 1 and the docking station 3000 may be equipped with transceivers capable of operating on multiple frequency bands and protocols, either as a primary means of communication or as a redundant or supplementary system for enhanced operational robustness. The selection among these multiple communication modalities may be governed by the behavior manager 1350 or the movement controller 1302, which may evaluate real-time factors such as spectral congestion, interference levels, data priority, power budget, and environmental conditions to determine the optimal modality at any given time. In another embodiment, the system may utilize alternative millimeter-wave, terahertz (THz), or optical frequencies. This may include the use of other millimeter-wave frequencies, such as the 28 GHz or 70 GHz bands, which may be selected based on the atmospheric absorption characteristics of a specific operational environment. The adoption of THz frequency bands, with their immense bandwidth potential, could enable the offload of terabytes of data, such as a complete high-resolution 3D scan of a facility, in a matter of seconds.

In another embodiment, the system may employ Multi-Band and Hybrid Radio Systems. This may include a tri-band Wi-Fi system operating on 2.4 GHz, 5 GHZ, and 6 GHz bands (e.g., Wi-Fi 6E/7). The behavior manager 1350 or movement controller 1302 of the robot 1 may be configured with sophisticated logic to dynamically switch between these frequency bands. This decision-making process could be based on real-time spectrum analysis to identify and avoid interference, the priority level of the data to be offloaded, or power-saving imperatives. For example, the less-congested 6 GHz band may be reserved for high-speed offloads of operational logs, while the 2.4 GHz band may be used for longer-range, lower-priority “heartbeat” communications. Furthermore, the system may be configured for Cellular and Wi-Fi Aggregation, wherein the robot 1 simultaneously utilizes cellular (e.g., 4G LTE, 5G) and Wi-Fi connections, managing data streams across both links to aggregate bandwidth and provide seamless, uninterruptible link redundancy. This is advantageous in large, complex environments with inconsistent or patchy wireless coverage.

In yet another embodiment, the system may employ Optical and Light-Based Communication. This may include the utilization of advanced optical wireless communication (OWC), such as Light Fidelity (Li-Fi), wherein the docking station 3000 and the ambient facility lighting are equipped with Li-Fi-enabled LEDs. When docked, or even while performing tasks underneath such lighting, the robot 1 could receive data at very high speeds via modulated light signals, offering enhanced security as the signal is contained within the illuminated space. Alternatively, a Free-Space Optical (FSO) Communication link, such as a focused, Laser-Based Optical Communication link, may be established between precisely aligned transceivers on the robot 1 and docking station 3000. The docking process itself would ensure the sub-millimeter alignment accuracy suited for these highly directional, interference-free links. Infrared data offload methods may also be used as a secure, short-range communication channel, immune to RF interference.

In a further embodiment, the system may utilize Near-Field Communication (NFC) and Magnetic Induction. The robot 1 may use an NFC transceiver to perform an initial secure “handshake” with the docking station 3000. This low-power transaction could securely exchange cryptographic keys, network credentials, or data payload manifests before activating the main, higher-power communication link, thereby hardening the system against unauthorized access. Furthermore, data may be transferred via Inductive Coupling, multiplexing a data signal onto the same magnetic field used for wireless power transfer, providing a reliable and secure short-range data exchange. In some embodiments, the inductive coupling data channel and the wireless power transfer channel may operate concurrently, with frequency-domain or time-domain multiplexing used to isolate the data signal from the power transfer signal.

In other contemplated embodiments, the system may integrate Ultra-Wideband (UWB) technology for both low-power communication and high-precision ranging, using time-of-flight measurements to guide the final centimeter-level alignment for docking. The system may also incorporate Quantum Communications, such as a quantum-key distribution (QKD) system, to generate and exchange provably secure encryption keys for the wireless data link, ensuring maximum data security for applications in defense or corporate espionage-sensitive environments. For extreme energy efficiency, the system may utilize Ambient Backscatter Communication, leveraging ambient RF signals (e.g., from Wi-Fi or cellular networks) as a carrier wave to transmit low-rate data without expending its own battery power. The system may also be configured to use next-generation wireless standards, such as Wi-Fi 7 or beyond, and may integrate with on-site 5G/6G Integrated Small Cells for direct, high-speed, low-latency network connectivity.

iii. Alternative Data Transfer Methods

In some embodiments, the system may utilize unconventional methods for data transfer, for specialized environments or data needs. In one such embodiment, the system may employ Acoustic Data Transmission. In environments with high electromagnetic interference, such as a factory with heavy arc welding equipment, the robot 1 and docking station 3000 may be equipped with ultrasonic transceivers to provide a reliable, short-range data link that is immune to the ambient RF interference. The ultrasonic transceivers may operate at frequencies above 20 kHz and below 1 MHZ, and the acoustic data link may employ error-correction coding and adaptive modulation techniques to maintain data integrity under varying environmental noise conditions.

In another embodiment, the system may utilize Physical Data Transfer. The robot 1 may be equipped with a hot-swappable module for a Swappable Solid-State Drive (SSD). As part of a maintenance or dedicated task cycle, the robot 1 could execute a precise manipulation task to navigate to a receptacle, eject a full SSD, and retrieve an empty one. The SSD module may be secured by a latching mechanism that prevents accidental ejection during locomotion and may include a wear-leveling controller to extend the operational lifespan of the storage media.

In a further embodiment, the robot 1 may use a specialized Data Probe End-Effector to connect to a high-speed data port, such as a fiber optic terminal, with sub-millimeter precision. The Data Probe End-Effector may include compliance mechanisms, such as a spring-loaded tip, to accommodate minor positional errors during the insertion process without damaging the port or the probe. In a further embodiment, the system may support Haptic and Conductive Communication. The hands or end-effectors of the robot 1 may be equipped with conductive pads. When manipulating or inspecting a tool or object that is connected to a network, the robot 1 could offload inspection data through the same points of contact, treating the data transfer as an integral part of the manipulation task.

iv. Alternative AI Processing

In some embodiments, the management of data, the transfer protocols, and the security thereof may be enhanced through artificial intelligence and advanced cryptographic methods. In one such embodiment, the system may utilize AI-Powered Data Management and Operational Data Management and Optimization. The onboard AI system 1470 of the robot 1 may perform onboard data pre-processing and compression. This may include Federated Learning, a privacy-preserving technique wherein the robot 1 processes raw sensor data (e.g., video of a workspace) to train a local AI model and only offloads the much smaller, anonymized model updates or gradients, ensuring sensitive raw data never leaves the robot. The AI may also perform predictive data offloading and AI-driven predictive offload scheduling, anticipating future data generation rates to proactively schedule offloads. The system may also employ smart data prioritization techniques and localized data caching strategies.

In another embodiment, the system may utilize Advanced Data Transfer Protocols. This may include quantum-inspired data compression techniques to reduce the size of offloaded datasets. The system may employ advanced error-correction and self-healing algorithms; for example, if a data packet is lost in a video stream, the protocol could use the surrounding frames to predict the content of the lost packet, reducing the need for retransmission. The system may also feature dynamic frequency management, wherein an AI-driven process performs real-time adjustment of communication frequency and protocols. In some embodiments, the AI-driven dynamic frequency management may operate in concert with the beam-steering capabilities of the mmWave transceivers 3412, jointly optimizing both the spatial and spectral characteristics of the communication link to maximize throughput under time-varying channel conditions.

### E. Docking Station

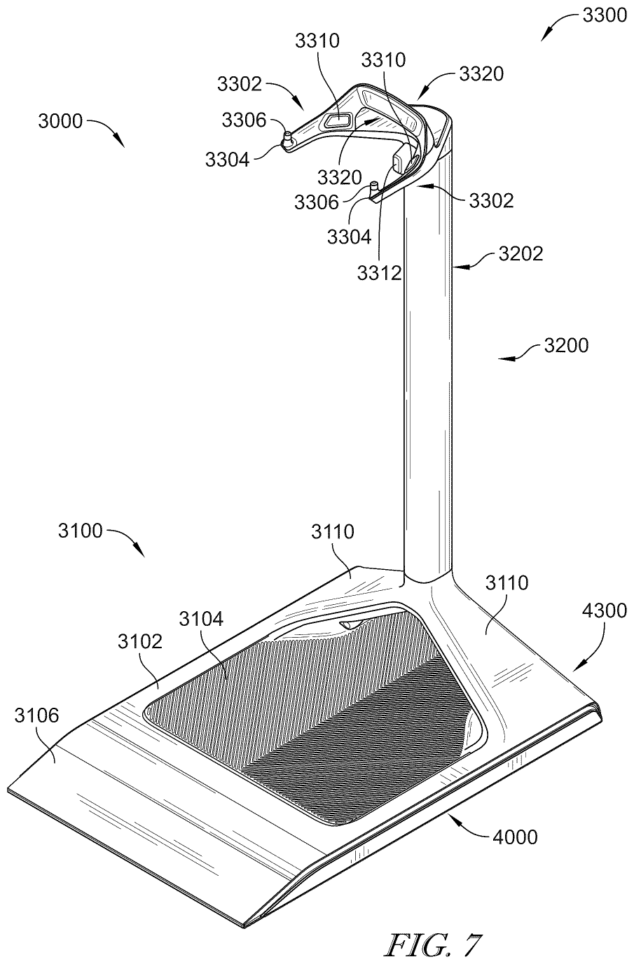

Referring to FIGS. 7-18, a docking station 3000 includes: (i) a base 3100, (ii) a flared base 3110, (iii) a vertical support arm 3200, (iv) a support cradle 3300 positioned above the base 3100 and configured to mechanically couple with the robot 1, and (v) a station electronics assembly 3500 including a communication transceiver module 3400 arranged in the support cradle 3300 and communicatively coupled to a station computing device 4350. The support cradle 3300 is coupled to an upper end of the vertical support arm 3200, positioned over the base 3100, and configured to mechanically and communicatively couple with the robot 1 at its waist 604. The docking station 3000 is configured to couple with and support the robot 1 in a position such that the communication transceiver module 604.3400 housed in the waist 604 of the robot 1 is aligned with the communication transceiver module 3400 in the support cradle 3300. The station computing device 4350 and the communication transceiver module 3400 are configured to form a data communication link with the communication transceiver module 604.3400 of the robot 1. The docking station 3000 may also include thermal management features and additional sensors to facilitate docking.

In the illustrative embodiment, the docking station 3000 includes a wireless power transfer (WPT) system 4000 contained in the base 3100 that is configured for inductive charging of the robot's battery pack 202 via its feet 92. The WPT system 4000 may include a wireless power transmitter device configured with transmitter coils to transfer power to the robot 1, where the robot 1 is configured to receive power by induction. In the illustrative embodiment, the robot 1 includes a wireless charging system including receiver coils in the left and right feet 92. Details regarding the wireless power transfer (WPT) system 4000 are further disclosed in U.S. patent application Ser. No. 19/321,022, which is incorporated herein by reference. In other embodiments, the docking station 3000 may be configured for data download only via the support cradle 3300, where the wireless power transfer (WPT) system 4000 is omitted from the base 3100.

The support cradle 3300 is positioned in a forward-projecting, cantilevered manner relative to the vertical support arm 3200. This configuration allows the robot 1 to reverse backward into the support cradle 3300. This cantilevered design also ensures that the robot 1 coupled with the docking station 3000 maintains stability by keeping the robot's center of mass positioned directly over the most stable part of the base 3100, for example, the center 3120. The wide stance of the base 3100 relative to the overall height of the vertical support arm 3200 also increases the stability of the docking station 3000. This enables the robot 1 to be positioned in a forward-facing direction, wherein the support cradle 3300 is positioned at a predetermined distance that places the center of gravity of the robot 1 proximal to the center 3120 of the base 3100, and/or places the robot's feet 92 proximal to the center 3120 (e.g., in a target “sweet spot” of the charging coils).

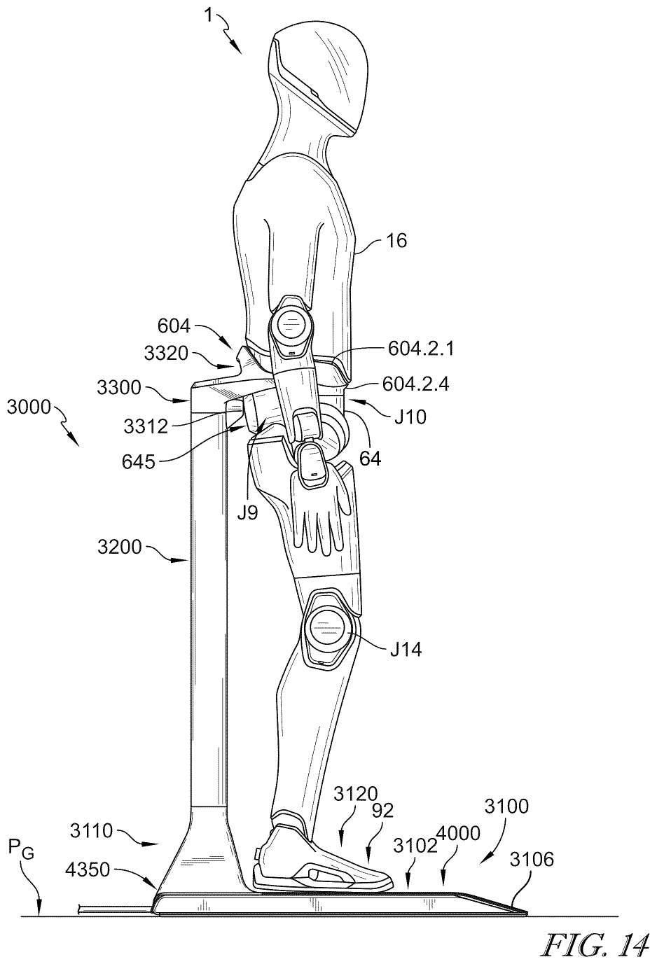

As illustrated in FIG. 14, in a docked state, the robot 1 is positioned with its feet 92 on the base 3100 of the docking station 3000 and supported at the waist 604 from the rear by the support cradle 3300. The rear engagement between the docking station 3000 and the robot 1 represents a significant departure from the design of conventional docks. In particular, conventional docks that facilitate forward engagement between a robot and a dock may be sufficient for mechanically stable wheeled platforms, but these conventional docks are inadequate for humanoid embodiments that pose a higher center of gravity, feature sensors, manipulators, and communication arrays on their anterior side, and need to occupy a minimal floor-based footprint while allowing for autonomous docking. This configuration also unconventionally leaves the forward-facing operational systems of the robot 1 entirely unobstructed, permitting the robot to continue monitoring its environment and/or communicating while securely docked. Other benefits of utilizing a rearward supporting design may be obvious to one of ordinary skill in the art based on the present disclosure and the accompanying figures. For example, rear engagement avoids interference with forward-facing sensor fields of view, preserves the ability of the robot 1 to interact with objects or persons in front of it while docked, and reduces the likelihood that the docking station 3000 obstructs pedestrian traffic in human-centric environments.

The materials for each component of the docking station 3000 may be selected to optimize its particular performance characteristics. In some embodiments, the base 3100 may be constructed from a high-density, weighted polymer composite to provide a low center of gravity and improved stability against tipping, while the vertical support arm 3200 may be formed from polymers, plastics, aluminum, steel, or other materials. For example, the vertical support arm 3200 may be formed from extruded aluminum or steel, or alternatively formed from carbon fiber to achieve a high strength-to-weight ratio. As such, any component of the docking station 3000 can be manufactured using any known method, including injection molding, casting, machining, or additive manufacturing. In some embodiments, dissimilar materials may be joined using adhesive bonding, mechanical fasteners, or co-molding techniques to achieve the desired combination of structural strength, weight, and RF transparency for different regions of the docking station 3000.

a. Base and Support Arm

The base 3100 includes a base housing 3150 configured to substantially enclose the WPT system 4000 and provide stability for the docking station 3000. The base 3100 features a low-profile design (e.g., with an upper surface that is less than 8 inches, preferably less than 5 inches, and most preferably less than 2 inches above a support surface) dimensioned to facilitate positioning of the robot 1 to couple with the docking station 3000, including spacing and placement of the robot's feet 92. The low-profile design reduces the step-up height that the robot 1 must negotiate when approaching the docking station 3000, thereby simplifying the gait pattern transition during the final approach phase and reducing the mechanical stresses on the robot's ankle and foot actuators.

The base 3100 has a substantially flat or planar base platform surface 3102, which terminates at its front in a beveled front edge 3106 (also called a ramped portion). The base 3100 may include a recessed portion to help define a dedicated wireless charging surface 3104. Said wireless charging surface 3104 may occupy less than the entire planar base platform surface 3102 and preferably a majority of the planar base platform surface 3102. Said planar base platform surface 3102, and more specifically the wireless charging surface 3104, is designed to support and underlie the feet 92 of the robot 1 for wireless charging. This wireless charging surface 3104 may be textured with a high-friction material and/or may include clear visual markings to provide a distinct target for the foot 92 placement of the robot 1. In other embodiments, the wireless charging surface 3104 may not be textured (e.g., substantially smooth), may be transparent to show the internal electronics, may not include visual markings, and/or may include other indicia that are intended to communicate the brand, serial number, manufacture date, and/or any other information. The beveled edge 3106 of the base 3100 is configured to provide a gentle ramp to make the overall docking process more robust and reduce the likelihood of a trip or a stumble, and to meet various safety standards.

The vertical support arm 3200 extends generally upward from the flared base 3110 coupled to or integrated with the rear portion of the base platform surface 3102. The vertical support arm 3200 is configured to transfer loads from the support cradle 3300 to the base 3100. The geometry of the flared base 3110 creates a transition from the relatively narrow profile of the vertical support arm 3200 to a much wider footprint at the base 3100. Said flared geometry increases the stability of the docking station 3000 against any tipping or rocking moments that might be induced during the docking process. This shape also serves to distribute stress from any load that is applied to the vertical support arm 3200 over a larger area of the base 3100, thereby preventing any localized stress concentration. The angled surfaces of the flare also effectively act as integrated gussets, creating a rigid triangulated structure that efficiently translates any lateral and bending forces into simple tension and compression, thereby providing substantial structural reinforcement.

The vertical support arm 3200 is configured to provide structural support and a load path between the support cradle 3300 and the base 3100 via the flared base 3110. Further, the vertical support arm 3200 defines an interior cavity 3202 that provides a conduit through which one or more power and/or data buses may pass to deliver power and/or communications between the base 3100 and electronic components housed within the support cradle 3300. In the illustrative embodiment, the vertical support arm 3200 has a substantially ovoid profile, but in some embodiments, the profile may be any geometric shape in cross-section, including circular, square, triangular, polygonal, oval, or any other shape. The interior cavity 3202 may further accommodate cable management features such as clips, guides, or strain-relief anchors to secure the power and data buses against vibrational fatigue and to prevent interference with the structural integrity of the vertical support arm 3200.

The flared base portion 3110 provides the mechanical interface at the rear portion of the base 3100. It serves as the structural transition between the vertical support arm 3200 and the base 3100 and provides a rigid connection. The various surfaces of the flared base portion 3110 may be formed with rounded inside corners, which substantially reduces the occurrence of concentrated point stresses and increases the overall strength of the docking station 3000. The flared base 3110 has a triangulated structure having two legs or members that extend from the vertical support arm 3200 to couple at the left and right extents of the base 3100. The flared base 3110 includes a flare cavity 3208 configured to house components and is open to the interior cavity 3202 of the vertical support arm 3200. Power and/or data buses may pass through the flare cavity 3208 and/or the interior cavity 3202 of the vertical support arm 3200 to deliver power and/or communications between the base 3100 and electronic components housed within the support cradle 3300.

By transitioning from the narrow profile of the vertical support arm 3200 to a much wider footprint, the flare shape increases the stability of the docking station 3000. This flared shape also serves to distribute stress from any load applied to the vertical support arm 3200 over a much larger area of the base 3100. The angled surfaces of the flare also act as integrated gussets, creating a rigid triangulated structure that efficiently translates any lateral and bending forces into tension and compression, thereby providing substantial reinforcement to the overall structure. This method of construction, which in some embodiments can be achieved through a process like injection molding, casting, machining, or additive manufacturing, may result in a part that is both stronger and more rigid than a comparable bolted assembly.

b. Support Cradle

Referring to FIGS. 7-11, the support cradle 3300 is coupled to an upper extent of the vertical support arm 3200 and projects forward over the base 3100. The support cradle 3300 includes a cradle support frame 3340, a cradle shell 3342, a rear shell 3344, a tail shell 3345, vertical alignment posts 3306, side gripper pads 3310, a rear support pad 3312, and a communication transceiver module 3400. The cradle support frame 3340 is configured to transfer loads received by the support cradle 3300 to the base 3100 via the vertical support arm 3200. The communication transceiver module 3400 is coupled to the rear shell 3344, and the cradle shell 3342 and tail shell 3345 cooperate to enclose the communication transceiver module 3400 and form a cradle handle 3330 coupled to the cradle support frame 3340.

As shown in the figures, the rear shell 3344 is coupled to the cradle support frame 3340, providing support for the cradle shell 3342, which together help define a retaining aperture 3305 and provide vertical support as well as horizontal bracing for the rear and lateral sides of the robot 1. The cradle arms 3302 are defined forward of the cradle handle 3330 and include an extent of the cradle support frame 3340 and cradle shell 3342. Each cradle arm 3302 terminates at a tip end from which a vertical alignment post 3306 extends upward. The inner surface 3303 of the cradle shell 3342 is contoured to substantially match the complex three-dimensional geometry of the robot's waist 604. This contouring serves to distribute contact forces over a wide surface area, which helps prevent the creation of pressure points and ensures a snug, stable fit. The cradle arms 3302 may also include side gripper pads 3310 that provide a soft, high-friction contact point, thereby helping to prevent any slippage without marring the exterior surface finish of the robot 1. In alternative embodiments, only a portion of the inner surface 3303 of the cradle 3300 may be contoured to substantially match the robot's exterior surface, or the inner surface of the cradle 3300 may not be contoured to substantially match the robot's exterior surface.

The main cradle body 3301 is defined generally rearward of the cradle handle 3330 and includes a rear extent of the cradle support frame 3340 adjacent to the vertical support arm 3200 and the tail shell 3345. The tail shell 3345 substantially covers the rear extent of the cradle support frame 3340 and completes the enclosure of the cradle handle 3330, where an internal cavity formed therebetween provides a passage for wiring from the handle 3330 to the vertical support arm 3200. A rear support pad 3312 is positioned centrally on a forward surface of the cradle support frame 3340, where the support cradle 3300 is coupled to the vertical support arm 3200. The rear support pad 3312 is positioned centrally to provide stable, anti-rotational support to the back of the robot's pelvis 64, as well as a soft, high friction contact point, preventing slippage without marring the robot's exterior finish. In some embodiments, the rear support pad 3312 may be formed from a viscoelastic material configured to conform to minor surface irregularities on the pelvis 64 of the robot 1, thereby increasing the contact area and the friction force available to resist rotation.

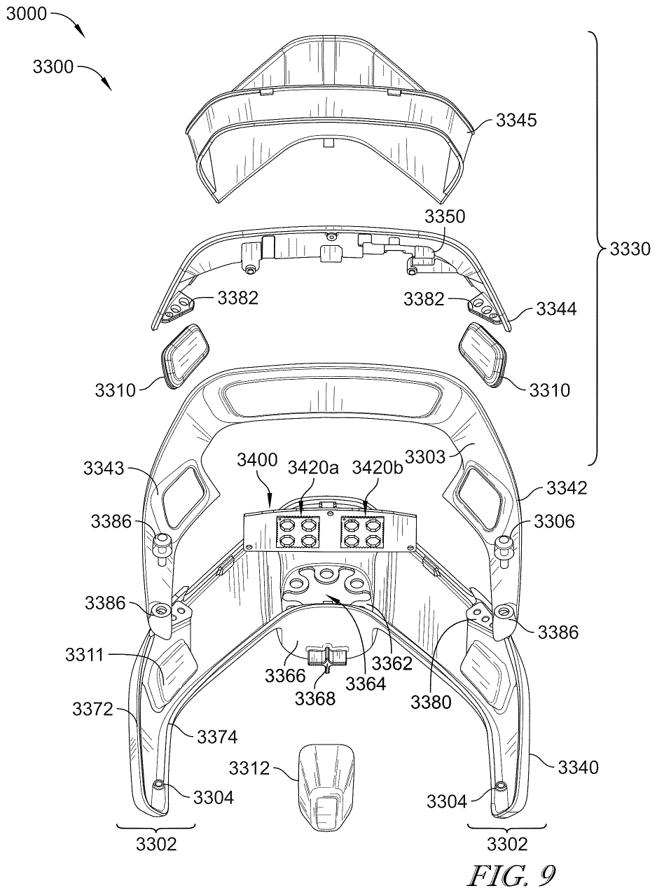

Referring to FIGS. 8-9, the cradle support frame 3340 includes a coupling portion 3360 and support arms 3370, where the coupling portion 3360 is configured to couple to the vertical support arm 3200 and the cradle support arms 3370 extend from the coupling portion 3360 to form a forked opening 3376. The coupling portion 3360 includes a mounting base 3362, a recessed opening 3364 formed in the mounting base 3362, a coupling wall 3366, and a support pad mount 3368 formed on a forward-facing exterior surface of the mounting base 3362. The mounting base 3362 is shaped to substantially match the perimeter shape of the vertical support arm 3200. The recessed opening 3364 cooperates with the interior cavity of the vertical support arm 3200 to allow for wiring passage between the communication transceiver module 3400 contained in the cradle handle 3330 and the station computing device 4350 positioned in the base 3100. The coupling wall 3366 extends upward from the mounting base 3362 around the recessed opening 3364 and transitions to the support arms 3370. For example, a lower edge of the mounting base 3362 may abut an upper edge of the vertical support arm 3200. The support pad mount 3368 is formed adjacent to the lower edge on the forward-facing extent of the mounting base 3362, so that when the rear support pad 3312 is coupled thereto, it may also overlap an extent of the vertical support arm 3200. In some embodiments, the cradle support frame 3340 may be formed in one piece with the vertical support arm 3200.

The cradle support arms 3370 extend symmetrically from the coupling portion 3360 and are formed with a curved shape to reduce point loads between the support arms 3370 and the vertical support arm 3200, thereby increasing the strength of the support arms 3370. The cradle support arms 3370 transition from the coupling wall 3366, extending forward on the left and right sides to a tip end 3371 forming an upper rim 3372 extending from the rear of the coupling wall 3366 and a lower rim 3374 forward of the vertical support arm 3200, where the lower rim 3374 partially defines a forked opening 3376. The cradle support arms 3370 may include reinforced or thickened sections to improve stiffness and may have an interior facing surface 3378 with mounting features, including handle mounts 3380, gripper mounts 3311, and alignment post seats 3304. Additionally, the upper rim 3372 may be configured to couple with at least the cradle shell 3342 and tail shell 3345.

The handle mounts 3380 are positioned on each of the cradle support arms 3370, forward of the coupling portion 3360, and configured to secure the left and right mounts 3382 of the rear shell 3344. The rear shell 3344 couples to the cradle support frame 3340 at the handle mounts 3380, where the communication transceiver module 3400 is coupled to a forward facing surface 3384 of the rear shell 3344. The cradle shell 3342, rear shell 3344, and tail shell 3345 cooperate to enclose the communication transceiver module 3400 and form a cradle handle 3330 coupled to the cradle support frame 3340. In particular, the cradle shell 3342 couples to the cradle support frame 3340 and an extent of the rear shell 3344, defining the support arms 3302 and the retaining aperture 3305. The tail shell 3345 couples to an extent of the cradle shell 3342 and rear shell 3344 to form a bottom extent of the handle and extends rearward to cover a rear extent of the cradle support frame 3340. The tail shell 3345 helps define an access opening 3320 formed by the cradle handle 3330 and an extent of the forked opening 3376 rearward of the cradle handle 3330, where the access opening 3320 provides access to grip the handle 3330 and allows airflow.

The gripper mounts 3311 are positioned on each of the cradle support arms 3370, forward of the handle mounts 3380 and rearward of the alignment post seats 3304 at the tip end 3371 of the cradle support arms 3370. Side gripper pads 3310 may be coupled to the gripper mounts 3311 on the inner surface of the cradle support arms 3370. These pads 3310 are configured to extend through apertures 3343 defined in the cradle shell 3342 in order to provide a soft, high-friction contact point, thereby helping to prevent any slippage without marring the exterior surface finish. Side gripper pads 3310 may be made from a durable elastomer such as polyurethane with a specified durometer measurement. Alternatively, the pads 3310 may be coupled directly to the cradle shell 3342. In some embodiments, the side gripper pads 3310 may be formed with a textured or ribbed contact surface to further increase the coefficient of friction between the pads 3310 and the exterior surface of the robot 1.

The vertical alignment posts 3306 may extend through mounting holes 3386 in the cradle shell 3342 and secure to the cradle support frame 3340 at the alignment post seats 3304, such that the alignment posts 3306 are in an upright, substantially vertical position (e.g., perpendicular to the planar base platform surface 3102 of the base). The profile of the vertical alignment post 3306 may have a tapered or chamfered top surface. This geometry acts as a mechanical lead-in, effectively capturing the corresponding recess on the robot 1 and actively guiding it into final alignment, making the system more tolerant of small initial positional errors during the docking maneuver. While the primary function of the vertical alignment post 3306 is mechanical, its precise and repeatable engagement may make it a desirable location for incorporating additional functionalities. In some embodiments, the vertical alignment post 3306 may be configured to serve as a multi-function interface. For example, the vertical alignment post 3306 may be equipped with robust, spring-loaded electrical contacts that are designed to mate with corresponding conductive pads located within the recess of the robot's waist, thereby establishing a direct, high-amperage wired charging connection. This connection may be used to supplement the primary wireless charging system, thereby offering redundancy or enabling even higher-power rapid charging modes. In some embodiments, the vertical alignment posts 3306 may be configured to include various sensors that may be used to verify a nominal docking. For example, the vertical alignment posts 3306 may be configured to include integrated load cells that may be used to measure the amount of weight that is being placed upon each vertical alignment post 3306, in order to determine whether the robot 1 is fully docked and/or to determine that the robot 1 is evenly balanced upon the support cradle 3300. An uneven pressure distribution detected by the load cells would signal a misalignment, thereby prompting the robot 1 to make subtle micro-adjustments to its posture. In some embodiments, the vertical alignment posts 3306 may further include temperature sensors configured to monitor the thermal state of the contact interface, which may be used by the station computing device 4350 to detect thermal anomalies indicative of an elevated contact resistance or a degraded connection.

In some embodiments, the materials of the support cradle 3300 can be specifically selected to further enhance the communication link between the two communication transceivers 3400 and 604.3400. For example, the cradle shell 3342 may be made of an RF transparent material to minimize attenuation of signal. In some embodiments, portions of the support cradle 3300 include one or more layers of RF shielding or other attenuative materials in order to reflect or reduce any stray signals from the surrounding environment (e.g., from other nearby docking stations 3000) and thereby reduce their ability to interfere with the primary RF link that is established between the communication transceivers 3400 and 604.3400. Conversely, the support cradle 3300 may include one or more layers of RF shielding or attenuative materials to reduce or block the signals of the RF link between the communication transceivers 3400 and 604.3400 from propagating out beyond the immediate vicinity of the docking station 3000 and the robot 1. Such signal attenuation can help to prevent any crosstalk between multiple RF links that may exist between multiple docking stations 3000 and multiple robots 1 operating in a close environment, and/or can help to improve data security by reducing the distance that any stray signals can propagate to be detected by unauthorized eavesdroppers. In some embodiments, the RF shielding may be implemented as a conductive mesh or a metallized film laminated to the interior or exterior surface of the cradle shell 3342, with the shielding pattern configured to attenuate signals in the 60 GHz band while remaining substantially transparent to lower-frequency signals used for ancillary communications such as NFC or Bluetooth.

c. Communication Transceiver Module

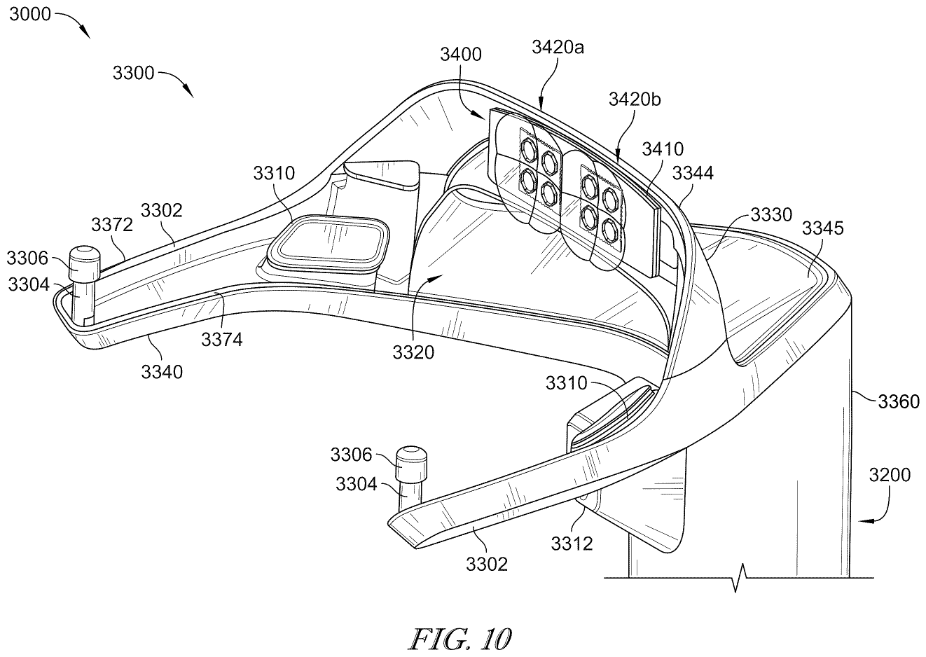

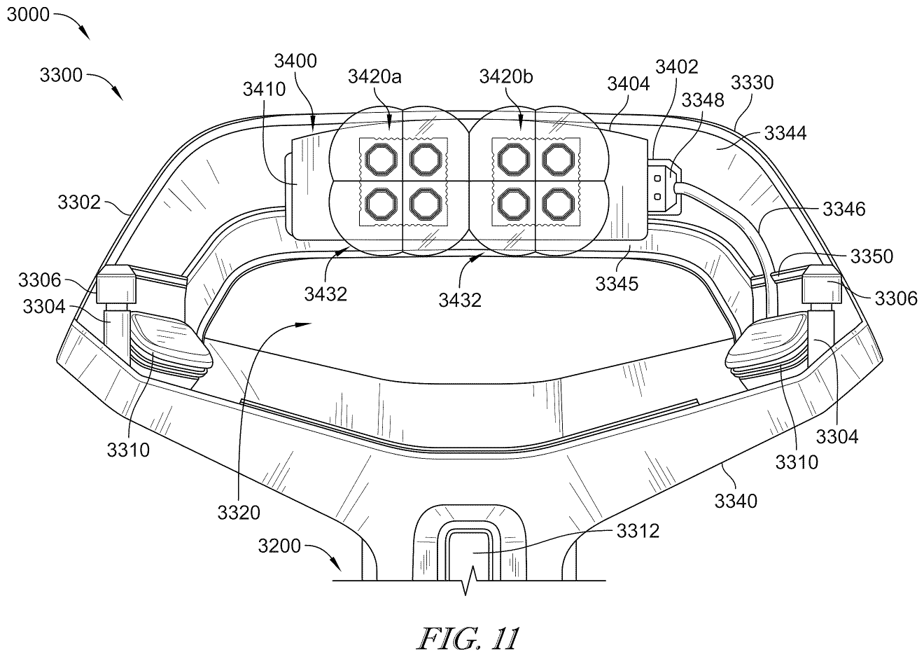

Referring to FIGS. 10-11, the cradle shell 3342 has been removed to illustrate the arrangement of the communication transceiver module 3400 within the structure of the cradle handle 3330. The communication transceiver module 3400 is positioned in a substantially vertical position with the antenna elements 3430 and RF fields 3432 facing the retaining aperture 3305 between cradle arms 3302 of the support cradle 3300. The vertical position of the communication transceiver module 3400 is configured to align with the corresponding transceiver 604.3400 that is located in the waist 604 of the robot 1 when it is docked. The curved shape of the support cradle 3300 as the handle 3330 transitions to the cradle arms 3302 is configured to facilitate docking for high-bandwidth data communication. The alignment posts 3306 are configured to mechanically engage with the waist 604 of the robot 1 to position and align the corresponding transceiver 604.3400 with respect to the communication transceiver module 3400 in the support cradle 3300.

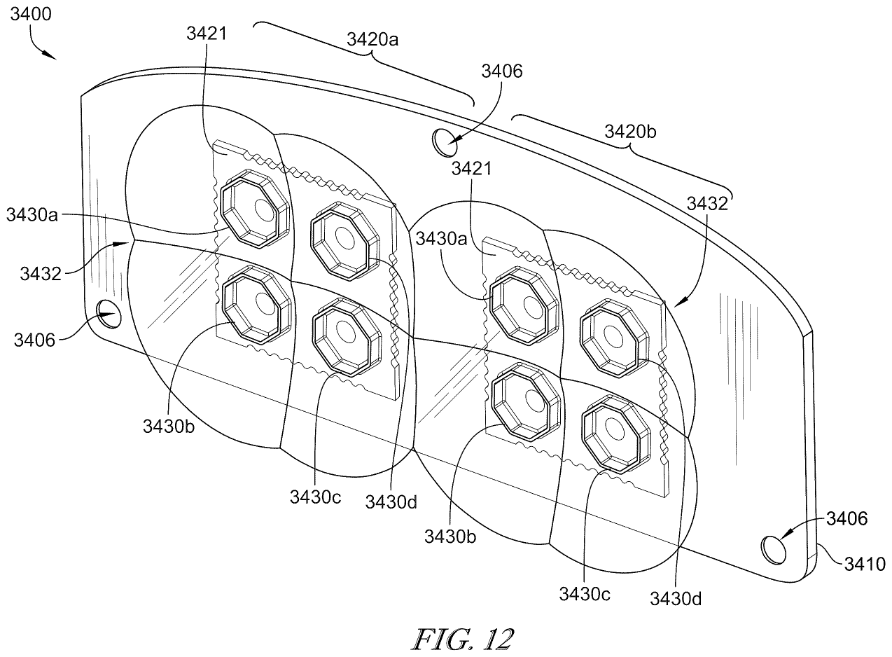

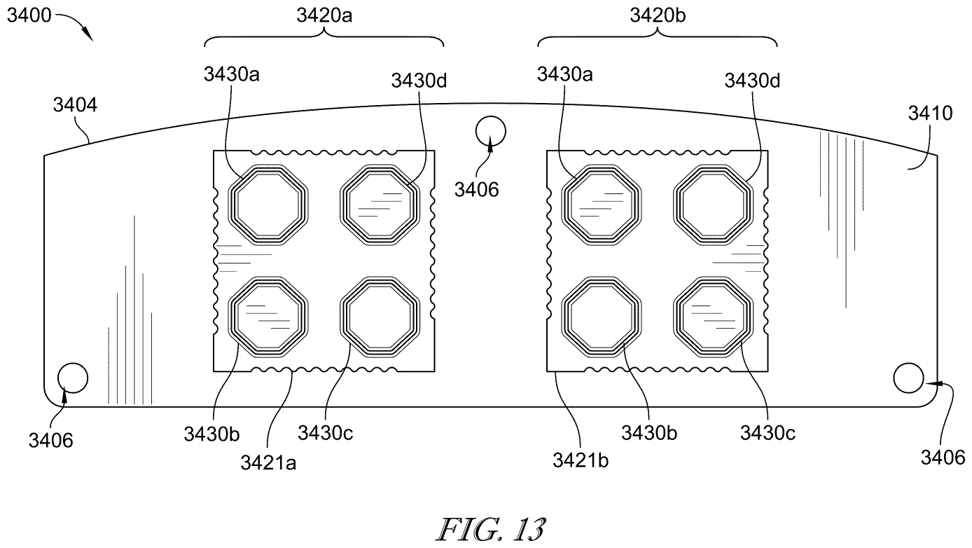

Referring to FIGS. 12-13, the communication transceiver module 3400 may be substantially the same as the communication transceiver module 604.3400 of the robot 1. In the illustrative embodiment, the communication transceiver module 3400 includes a main printed circuit board (PCB) 3410, upon which various supporting electronics and antenna array modules 3420a, 3420b are arranged side by side and spaced apart. The main PCB 3410 may be any shape sized to accommodate the antenna array modules 3420a, 3420b and fit into the compact space of the cradle handle 3330 and may include mounting features. For example, the physical volume within the cradle handle may be sized about 40 mm in length, about 25 mm in height, and about 10 mm in depth. In the illustrative embodiment, the main PCB 3410 is substantially rectangular in shape with a curved edge 3404 and includes several mounting holes 3406. In other embodiments, one or both of the communication transceiver modules 604.3400, 3400 may be embodied to accommodate separate antenna array modules 3420a, 3420b in separate PCB assemblies.

In an example, the substrate material of the PCB 3410 can be a specialized high-frequency laminate material, such as a material from the Rogers RO4000® series or a similar high-performance material, which may be selected for its stable dielectric constant and its low loss tangent at millimeter-wave frequencies. In the example, the four antenna elements 3430 and mmWave transceivers 3412 of each antenna array module 3420a, 3420b are provided as a single unit, shown with castellations along the edges for a low-profile coupling with the PCB 3410 and other circuitry. In the illustrative embodiment, the four octagonal antenna elements 3430 within each antenna array module 3420 are shown in the illustrated example as being arranged in a two-by-two grid pattern. The physical separation between the two arrays of antenna elements 3430 helps to improve the electrical isolation and thereby reduce the cross-talk between the lanes of the first and second antenna array modules 3420a, 3420b. In some embodiments, the PCB 3410 may further include ground plane structures, via fences, or electromagnetic bandgap structures positioned between the antenna array modules 3420a, 3420b to further suppress mutual coupling and enhance inter-lane isolation.

d. Coupling of Robot and Docking Station

As shown in FIGS. 14-16, the support cradle 3300 is configured to engage with the posterior and lateral aspects of the robot 1 at its waist 604. In this engaged position, the robot 1 maintains a natural, upright posture and provides robust, multi-axis mechanical support, which effectively offloads the static gravitational load from the robot's own actuators onto the docking station 3000. Said upright posture may be conducive to long-term autonomous operation by allowing the robot 1 to be supported by the support cradle 3300 while simultaneously positioned for data offload via communication transceiver module 3400 and optionally receiving wireless charging power via the base 3100. Additionally, this upright posture may be advantageous for operations in human-centric environments where available floor space may be limited and where the robot 1 should maintain a minimal physical footprint to avoid causing an obstruction.

The docking station 3000 is configured such that when the robot 1 is received into the support cradle 3300 and docked, the communication transceiver module 604.3400 of the robot 1 and the communication transceiver module 3400 of the docking station 3000 are substantially parallel to each other and separated by only a small or minimal separation gap 3434 (e.g., 5 mm, 1 cm, 2 cm, or 5 cm). The cradle arms 3302 are shaped to form a guiding, funnel-like U-shaped geometry (e.g., retaining aperture 3305). This shape provides a form of passive mechanical guidance, creating a wide entry point that naturally corrects for any minor lateral misalignments as the robot 1 reverses into the docking station 3000. Each cradle arm 3302 terminates with an alignment post 3306 extending upward in a substantially vertical direction. This symmetry helps to simplify the docking process, as a symmetrical target is significantly easier for the robot's perception system 1420 to identify and model. The vertical alignment posts 3306 of the cradle arms 3302 are designed to function as part of a high-precision kinematic coupling and are designed to engage with corresponding concave recesses 604.6.2 that are located on the waist 604 of the robot 1. This physical engagement provides definitive tactile feedback to the internal sensors 1.2.8 of the robot 1 and ensures a repeatable final docked position.

FIG. 15 shows the close positional relationship between the robot 1 and an extent of the docking station 3000. In particular, the support cradle 3300 is shaped to match the complex three-dimensional contours of the waist 604 of the robot 1, providing stability and an even distribution of the supported load. The robot 1 is properly positioned when the vertical alignment posts 3306 of the docking station 3000 are engaged with the concave recesses 604.6.2 of the robot's waist 604 and a rear extent of the pelvis 64 (e.g., the rear cover 645 of the torso lean actuator J9). This docked state facilitates allowing the robot 1 to be supported and simultaneously positioned for wireless data offload and/or wireless charging power. In this securely supported state, the robot 1 can transition into a deep low-power or standby mode. The provided physical support also ensures the stability of the robot 1 against any accidental bumps or environmental vibrations, thereby preventing falls that might otherwise occur if the robot 1 were to power down its active balancing systems while it was free-standing.

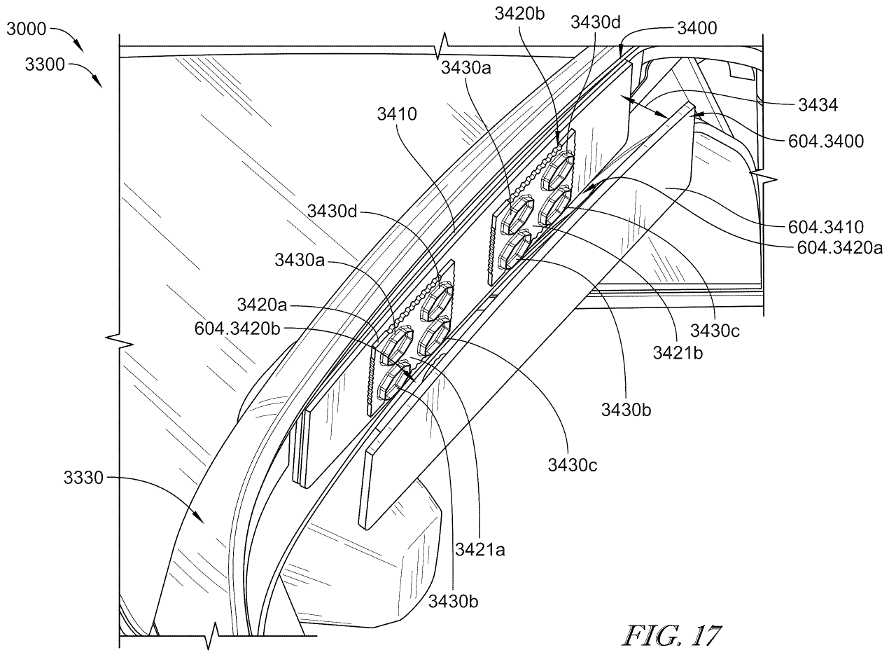

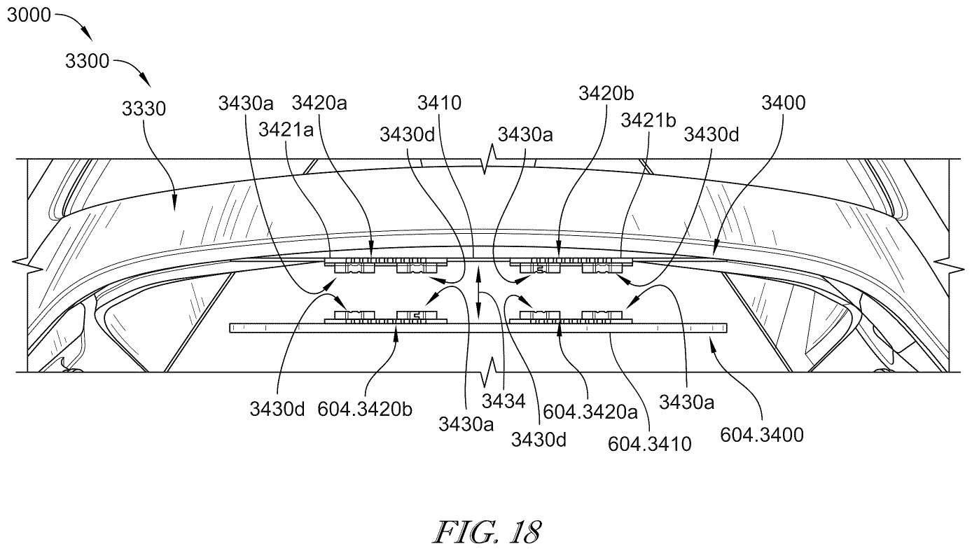

In FIGS. 17-18, the operative position of the communication transceiver modules 604.3400, 3400 with the separation gap 3434 is illustrated. To illustrate the alignment, the individual antenna elements 3430a-d are identified in the same order as shown in the non-limiting example of FIG. 13. In this example, both communication transceiver modules 604.3400, 3400 include antenna elements 3430a, 3430b configured to transmit and antenna elements 3430c, 3430d configured to receive (also shown in FIG. 6). As such when the communication transceiver modules 604.3400, 3400 are facing each other, antenna elements 3430a, 3430b (Tx pair) of communication transceiver module 604.3400 face antenna elements 3430d, 3430c (Rx pair) of communication transceiver module 3400, and vice versa.

The relative position of the communication transceiver modules 604.3400, 3400 are shown in alignment and shown without the waist body 604.2 of the robot 1 or cradle shell 3342 of the docking station 3000. As can be understood, the waist body 604.2 and the cradle shell 3342 will enclose the respective modules resulting in layers of structure positioned within the separation gap 3434. To minimize signal loss, the waist body 604.2 and the cradle shell 3342 may be made of an RF transparent material (e.g., thermoplastics, fiberglass, polyethylene) that allows radio waves to pass through with minimal signal loss or attenuation. For example, when the robot 1 is fully docked, the rear surface of the waist 604 of the robot 1 may be in contact with the surface of the cradle shell 3342 at the cradle handle 3330, which spaces the communication transceiver modules 604.3400, 3400 within an allowable separation gap 3434. In some embodiments, the RF transparent material may be selected to have a dielectric constant between approximately 2.0 and 4.0 and a loss tangent of less than 0.01 at 60 GHz to maintain acceptable signal integrity across the separation gap 3434.

In some embodiments, the thickness, height, and/or other physical dimensions of the side gripper pads 3310, the rear support pad 3312, the alignment post seats 3304, and/or the vertical alignment posts 3306 can be specifically selected to help set the final width of the separation gap 3434 when the robot 1 is in its fully docked configuration. In some embodiments, the side gripper pads 3310, the rear support pad 3312, the alignment post seats 3304, and/or the vertical alignment posts 3306 can be made to be adjustable, for example, to allow for the fine tuning of the size of the separation gap 3434 and/or the final alignment of the antenna array modules 604.3420a/b and 3420b/a. In some embodiments, the side gripper pads 3310, the rear support pad 3312, the alignment post seats 3304, and/or the vertical alignment posts 3306 can be designed to be interchangeable with other similar elements that have different physical dimensions. For example, the vertical alignment posts 3306 could be exchanged for taller vertical alignment posts in order to slightly (e.g., by 1-2 mm) raise the waist 604 of the robot 1 relative to the support cradle 3300 and thereby slightly elevate the antenna array modules 604.3420 of the robot 1 relative to the antenna array modules 3420 of the docking station 3000. In some embodiments, the vertical alignment posts 3306 can be configured with an offset or an eccentric adjustability feature, in which the vertical alignment post 3306 slightly orbits around its respective alignment post seat 3304 in order to provide some degree of lateral adjustability that can be used to slightly alter the final position of the waist 604 relative to the support cradle 3300, and in turn slightly alter the fine alignment of the antenna array module 604.3420 relative to the antenna array module 3420 when the robot 1 is in its docked state.

e. Wireless Data Offload System

The wireless data offload system includes a first communication transceiver module 604.3400 positioned within the waist portion 604 of the robot 1 and a corresponding second communication transceiver module 3400 positioned in the support cradle 3300. Said wireless data offload system creates a contactless data connection to facilitate the rapid offloading of voluminous operational and sensory datasets that are generated and stored by the robot 1 during its operational cycles. The docking station 3000 provides for advantageous physical stabilization and includes a support cradle 3300 configured to couple with the robot 1 so that the communication transceiver modules 604.3400, 3400 are positioned at a predefined separation gap 3434 to establish a high-bandwidth, short-range wireless data connection. The offloading of these large datasets is an architectural feature for an advanced robotics platform as it allows the robot 1 to collect operational data that can later be used by a cloud-based AI system 2780 to train, modify, alter, or generate new and/or more advanced models. This offload capability directly addresses the fundamental size, weight, power, and cost (SWaP-C) limitations that are inherent to any untethered, mobile humanoid platform.

The selection of the 60 GHz band, or other similar millimeter-wave frequency segments, allows for multi-gigabit data throughput. However, this choice of frequency also introduces significant technical challenges that are effectively addressed by the physical docking architecture. Millimeter-wave signals are characterized by very high path loss and are also subject to significant absorption by atmospheric oxygen, a phenomenon which peaks in the 60 GHz band. These physical phenomena can limit the effective transmission distance of such signals. To counteract this signal attenuation, the wireless data offload system can be designed to rely on high-gain, phased-array antennas that are capable of focusing the RF signal into a narrow, directional beam. While this technique concentrates the signal power effectively, it also creates a significant pointing and alignment consideration; a minor angular deviation between the transmitting and receiving antennas can cause the communication link to degrade or fail.

The robust mechanical interface of the docking station 3000 can effectively resolve this inherent trade-off. The docking maneuver transforms a difficult mobile communication problem into a simpler quasi-static one. The process may be designed to function as a multi-stage connection protocol: an initial gross alignment is performed by the navigation system of the robot 1, a subsequent fine mechanical alignment is achieved as the physical contours of the waist 604 of the robot 1 mate with the support cradle 3300, and a final micro-alignment can then be performed electronically via beam-steering techniques within the transceivers themselves. This mechanically enforced proximity and alignment positions the respective transceiver modules 3400 and 604.3400 such that only a narrow gap extends between them (as shown in FIG. 18). This, in turn, facilitates the subsequent electronic beamforming and link negotiation processes, thereby promoting the establishment of a stable, high-quality communication channel. This physical solution provides a degree of security against remote eavesdropping and also permits the high-density deployment of multiple docking stations 3000 in close proximity to one another without causing mutual interference.

The docking station 3000 maintains the robot 1 in a stable and stationary configuration to minimize errors that may occur during data transfer. In some embodiments, the robot 1 is constrained by its behavior manager 1350 from initiating any locomotive or other significant motion relative to the docking station 3000 until the data transfer protocol is either fully completed (e.g., as verified by a data integrity check such as a cyclic redundancy check (CRC)) or is otherwise intentionally terminated by a controlling system, such as the movement controller 1302 of the robot 1 or in response to an external directive from a command center 2750A-X. This strict protocol, which is made possible by secure mechanical docking, serves to promote a high degree of integrity for both the high-frequency communication link and the data payload that is being transferred across it. In some embodiments, the data transfer protocol may further include a multi-phase handshake sequence in which the station computing device 4350 and the compute 1000 of the robot 1 negotiate transfer parameters such as link modulation scheme, error-correction level, and data prioritization order before bulk data transfer commences.

The provision of this high-speed data interface permits the robot 1 to offload large, accumulated datasets and/or logs. These datasets may thereafter be relayed by the docking station 3000, which can act as a data conduit with its own potential internal buffering capabilities, to one or more remote command centers 2750A-X or to the cloud-based artificial intelligence system 2780 by means of a separate, high-speed network backhaul connection. In some embodiments, the station computing device 4350 may perform local deduplication, indexing, or pre-processing of the offloaded data before forwarding it to the remote command centers 2750A-X or the cloud-based AI system 2780, thereby reducing backhaul bandwidth consumption and accelerating downstream analytics workflows.

i. Data Offload While Charging

In various embodiments, robot 1 may collect data via sensors 1.2.8 during an operational runtime or work period. The operational runtime may be of any duration and/or limited by the capacity of the battery pack 202. For example, the operational runtime may be a period of 1 hour, 2 hours, 3 hours, 4 hours, 5 hours, 6 hours, or any duration therebetween. During this runtime, the sensor array of the robot 1 continuously collects data. Upon completion of its task or when the battery pack 202 reaches a predetermined low-level threshold, the robot 1 may connect to a docking station, which provides both a data link and a battery charger. In the illustrative embodiment, the docking station 3000 includes a wireless power transfer system 4000 and the communication transceiver module 3400 of the wireless data offload system. The high data throughput of the wireless data offload system allows for a data transfer rate for offloading the collected data that is significantly faster than the charging rate of the battery pack 202. This configuration ensures that data offloading does not become a bottleneck in the operational cycle of the robot 1, thereby maximizing the availability and uptime of the robot 1. For example, the relationship between the data transfer time (Toffload) and the battery charging time (Tcharge) is such that T_{offload}<T_{charge}. Stated another way, the data transfer rate is configured to be greater than the battery charge rate.

As a non-limiting, illustrative example, a robot 1 configured for a 4-hour autonomous operational runtime may collect data generated by various sensors 1.2.8 while performing a task, or set of tasks, and offload said data while coupled to the docking station 3000 to recharge its battery pack 202.
1. Data Generation and Volume: The sensors 1.2.8 of the robot 1 may include six vision sensors 1.2.8.6 (e.g., high-resolution cameras) generating a combined 67.5 gigabytes (GB) of data per hour; a suite of 30 torque sensors 1.2.8.2 (e.g., actuator encoders and torque cells) for proprioceptive feedback, generating approximately 1 GB of data per hour; high-fidelity tactile sensors 1.2.8.10 in each of its fingers and thumbs generating a combined 4.5 GB of data per hour; and an Inertial Measurement Unit (IMU) 1.2.8.4 with other auxiliary sensors 1.2.8.16 generating 2.25 GB of data per hour.
   Total Data Rate: 67.5+1.0+4.5+2.25=75.25 GB/hour
   Total Data Volume (Dtotal) for a 4-hour runtime: 75.25 GB/hour×4 hours=301 GB
2. Data Offload Time (Toffload): The robot 1 is configured to offload this data via a high-speed data link, such as a wireless high data rate connection using communication transceiver modules 604.3400, 3400 providing a sustained transfer rate of 10 gigabits per second (Gbps), which is equivalent to 1250 megabytes per second (MB/s), equivalent to 1175 MB/s due to protocol overhead.
   T_{offload}=301,000 MB/1175 MB/s=256 seconds=~5-15 minutes (to account for data read/write and error correction)
3. Battery Charging Time (T_{charge}): The battery pack 202 of the robot 1 has a capacity of 2.5 kilowatt-hours (kWh), or 2500 Watt-hours (Wh). The charging system, whether wired or wireless, delivers power at a rate of 2 kilowatts (kW), or 2000 Watts (W).
   T_{charge}=2500 Wh/2000 W=1.25-3 hours (to account for charging inefficiencies).

In this example, the time required to offload all 301 GB of data collected during a 4-hour operational runtime period is approximately 5-15 minutes. The time required to fully recharge the battery 202 is approximately 1.25 hours (or 75 minutes). Therefore, the system is configured such that the data offload process is completed in a fraction of the time required for the charging process (T_{offload}<T_{charge}). This allows for the data to be immediately available for processing, analysis, or archiving long before the robot 1 is physically ready for its next deployment, thereby optimizing the entire operational workflow. The principle holds for various operational runtimes, wherein the total data collected during the discharge cycle of the battery pack 202 can be transferred in a time period substantially shorter than the subsequent charge cycle. In other words, said wireless transfer system enables the robot 1 to offload all data collected during its battery runtime (e.g., more than each of the following: 1 hour, 2 hours, 3 hours, 4 hours, 5 hours, 6 hours, or any time therebetween) before its battery pack 202 can fully charge using a wired or wireless charger. In other words, it takes longer to charge the battery pack 202 of the robot 1 than it does to offload the data collected during autonomous or implementation runs.

ii. Additional Data Exchange

The aforementioned data interface is architected not merely for simple bulk data transfer but also to facilitate the interchange of information that pertains to functional safety. Said interchange of information may be configured to be in full compliance with principles that are outlined in IEC 61508-2:2010, thereby supporting various verification and validation activities. In addition to the previously described operational and machine learning-related data, the datasets that are offloaded by means of this specialized interface may include, without limitation, several discrete categories of information. Such categories can encompass data concerning the operational enablement state of the robot 1 for the purpose of system-wide monitoring and robot fleet management, time-stamped records that contain the identification and spatial location of any detected objects and individuals for the purpose of forensic analysis and for the future refinement of collaborative or socially-aware behaviors, unprocessed, raw sensor feedback originating from the onboard sensitive protective equipment (e.g., such as from the torque sensors 1.2.8.2 or the proximity sensors 1.2.8.12) which permits a more sophisticated and granular offline analysis than would be possible with pre-processed data, and/or detailed data memorializing some or all of the alterations to the position or trajectory of the robot 1 that occur as a function of its autonomous obstacle or collision avoidance maneuvers, thereby providing a verifiable log of its internal decision-making process. The offloaded datasets may further include hardware diagnostic telemetry, such as actuator temperature histories, battery cell voltage profiles, and bearing vibration spectra, which enable predictive maintenance algorithms running on the remote AI system 2780 to forecast component degradation and schedule proactive replacements before operational failures occur.

Furthermore, it is contemplated that the robot 1 may be configured to apprise a human user or a system administrator of the real-time operational characteristics of the data interface, conveying such diagnostic information either through a synthesized voice output from the human-robot communication interface 1.2.12.8 or by means of a visual display that is integrated into its chassis. The ready availability of this real-time information can be useful for maintenance purposes, for link-quality monitoring, and for system verification purposes. Such operational characteristics to be communicated may encompass, by way of non-limiting example, the current operating frequency of the link, its measured end-to-end latency, the measured signal jitter which can impact the quality of time-sensitive data streams, the degree of determinism in the data packet arrival, and the effective data update rate or throughput of the link. These metrics, when they are logged and transmitted to a command center 2750A-X, can be collectively analyzed to provide a comprehensive assessment of the overall health and performance of the communication channel, potentially enabling predictive maintenance alerts upon the detection of degrading signal quality long before a component failure actually occurs.

### F. Alternative Embodiments

In alternative embodiments, the robot 1 may couple with alternative external devices configured with the communication transceiver module 3400 for data download. It should be noted that other embodiments that are similar to these, or embodiments that combine one or more of the below disclosed features with the above disclosed features, are contemplated herein. In other words, any feature, element, component, or function of any embodiment disclosed herein can be combined with any other feature, element, component, or function disclosed herein. The following alternative embodiments are presented to illustrate the breadth of configurations in which the wireless data offload system may be implemented, and one of ordinary skill in the art will appreciate that further combinations and permutations beyond those explicitly described are within the scope of this disclosure.

a. Alternative Wireless Coupling Configurations

FIGS. 19-20 illustrate alternative configurations for positioning the communication transceiver 604.3400 in the robot 1 for the high data rate wireless data offload system. For sake of brevity, the above disclosure in connection with the communication transceiver module 604.3400, 3400 will not be repeated below, but it should be understood that across embodiments like numbers represent like structures. In these alternative embodiments, the docking station 3000 is replaced with an alternative data offload device 13050, 23050, 33050, 43050, 53050 that contains a communication transceiver module 13400, 23400, 33400, 43400, 53400. Each alternative data offload device may be communicatively coupled to the station computing device 4350 or to a dedicated computing device specific to the alternative embodiment.

i. Waist

In an alternative embodiment, a communication transceiver module 10604.3400 in the waist 604 of the robot may communicatively couple with an alternative data offload device 13050. For example, alternative data offload device 13050 may be embodied as an alternative docking station, charging station, chair, wall mounted device, or portable device that includes a communication transceiver 13400 configured to wirelessly couple with the communication transceiver module 10604.3400. The communication transceiver module 10604.3400 is positioned in the waist 604, or alternatively a lower portion of the torso 16 in a region near the waist 604. The position of the communication transceiver module 10604.3400 may be selected to coincide with a structurally rigid portion of the robot's chassis in order to minimize relative movement between the transceiver and the exterior surface of the robot 1 during docking.

In one example, the alternative data offload device 13050 may include a substantially similar support cradle 13300 coupled to a different support structure. For example, the support cradle 13300 may be mounted on a post, a wall, or adjustable framework sufficient to support the weight of the robot 1, where the communication transceiver 13400 is coupled to a computing device. In another example, the alternative data offload device 13050 may be one of a plurality of alternative data offload devices 13050 arranged to couple directly to a single computing device. In another example, the alternative data offload device 13050 may be shaped with a retaining aperture 13305 similar to the support cradle 3300 for alignment of the communication transceiver modules 10604.3400, 13400, but is not intended to support the weight of the robot 1.

In another example, an alternative data offload device 13050 may be enhanced with active mechanisms. For example, the alternative data offload device 13050 may be similar to the support cradle 13300 and may feature Docking Station Grippers or other automated arms to physically secure and precisely align the robot 1. Stability may be enhanced through non-contact Magnetic Levitation Docking, which would provide a frictionless, self-centering, and perfectly aligned docking experience, or Vacuum-Suction Stabilization Pads and Air-Cushion Docking systems. In other examples, the cradle arms 13302 may be modular or the alternative data offload device 13050 may feature pivotable cradle or support arm configurations to accommodate various robot geometries.

In another example, the alternative data offload device 13050 may not include a cradle or support arms, where alternative data offload device 13050 is mounted on a post, a wall, or adjustable framework at a height that corresponds with the vertical location of the communication transceiver module 10604.3400 in the waist 604 of the robot 1, such that the robot 1 need only position itself with the communication transceiver module 10604.3400 facing the alternative data offload device 13050 to initiate the high rate data connection. In this configuration, the robot 1 maintains its own balance via its active balancing systems while the data offload is conducted, and the behavior manager 1350 may be configured to constrain the robot's locomotion to keep the transceiver modules within the acceptable separation gap and angular tolerance throughout the transfer session.

In an alternative configuration, the communication transceiver module 10604.3400 may be arranged in a frontal extent of the robot 1 to couple with the alternative data offload device 13050. In this forward facing example, the alternative data offload device 13050 may be coupled to a structure and positioned in front of the robot 1, so that the robot 1 may offload data while standing in a stationary position and performing a task that uses only movement of the arms 5 and/or head 10. This front-facing configuration may be advantageous in scenarios where the robot 1 is stationed at a workbench or assembly line and offloading data during brief idle intervals between task cycles.

Further, an alternative robot may additionally include internal mounts for the transceiver 10604.3400 within the waist 604 to dynamically adjust its position via micro-actuators, which use real-time signal strength measurements as a feedback mechanism to optimize the alignment of the transceiver. Alternatively or additionally, an alternative robot may also feature modular communication cartridges, allowing it to autonomously swap communication hardware modules to adapt to different environments or tasks. The modular communication cartridges may each contain a self-contained antenna array module, associated control electronics, and a standardized mechanical and electrical interface that mates with a cartridge bay defined within the waist 604 or other body segment of the robot 1.

ii. Torso

In an alternative embodiment, a communication transceiver module 20604.3400 in the torso 16 of the robot may communicatively couple with an alternative data offload device 23050 that includes communication transceiver module 23400. As shown in FIG. 19, the communication transceiver module 20604.3400 may be positioned in the torso of a robot, at the rear below the shoulder region. The alternative data offload device 23050 may be mounted on a wall, a post, or adjustable framework and positioned to align with the communication transceiver module 20604.3400 when standing within the separation gap 3434. In one example, the alternative data offload device 23050 may be included in a back support of a chair and configured to communicatively couple when the robot is seated in the chair. This seated-docking configuration may be advantageous in office or laboratory environments where the robot 1 can adopt a seated posture during data offload, conserving energy by reducing the load on its lower-limb actuators.

iii. Head

In an alternative embodiment, a communication transceiver module 30604.3400 in the head 10 of the robot may communicatively couple with an alternative data offload device 33050 that includes communication transceiver module 33400. As shown in FIG. 19, the communication transceiver module 30604.3400 may be positioned in the head of a robot. The alternative data offload device 33050 may be mounted on a wall, a post, or adjustable framework and arranged to couple with the head of the robot when positioned with an acceptable separation gap 3434. In one example, the alternative data offload device 33050 may be included in a head rest of a chair and configured to communicatively couple when the robot is seated in the chair.

Because the head is space constrained, the communication transceiver module 30604.3400 may be operatively the same with an alternative arrangement of antenna elements 33430. For example, the communication transceiver module 30604.3400 may be physically separated into two module units that separately include antenna array modules 33420a, 33420b. In another example, the individual antenna elements 33430 may be arranged to match the curved surface of the head shell and the alternative data offload device 33050 may have a corresponding arrangement to align the individual antenna elements 33430 to be within the separation gap 33434 (see also FIG. 6). In some embodiments, the antenna elements 33430 may be implemented as conformal antenna elements printed or etched onto a flexible substrate that conforms to the interior curvature of the head shell, thereby maximizing the use of the available volume within the head 10 while maintaining the antenna radiation pattern characteristics suited for the short-range link.

iv. Legs

In an alternative embodiment, a communication transceiver module 40604.3400 in the legs 6 of the robot 1 may communicatively couple with an alternative data offload device 43050 that includes communication transceiver module 43400. In this embodiment, communication transceiver module 604.3400 of the first embodiment is modified such that the communication transceiver module 40604.3400 is configured with the antenna array modules 43420a, 43420b in physically separate units and communicatively coupled to compute 1000 within the robot 1. As such the antenna array modules 43420a, 43420b cooperate to provide the high data rate offload via the communication transceiver module 43400 in the alternative data offload device 43050. The antenna array modules 43420a, 43420b are configured to be coupled with the left and right leg 6a, 6b of the robot 1 (e.g., within the shin 84). The communication transceiver module 43400 of the alternative data offload device 43050 includes antenna array modules 43420a, 43420b spaced to couple with separate antenna array modules 43420a, 43420b arranged in the legs 6a, 6b at a predefined distance. For example, the predefined distance may be based on a distance between the left and right legs 6a, 6b when the robot 1 is standing in a neutral state. In one example, the antenna array modules 43420a, 43420b are in the same housing of alternative data offload device 43050. In another example, the antenna array modules 43420a, 43420b are provided in separate housings of alternative data offload device 43050.

v. Feet

In an alternative embodiment, a communication transceiver module 50604.3400 in the feet 92 of the robot may communicatively couple with an alternative data offload device 53050 that includes communication transceiver module 53400. Similar to the communication transceiver module 40604.3400, communication transceiver module 50604.3400 includes two physically separate antenna array modules 53420a, 53420b arranged in the feet 92 of the robot 1 and communicatively coupled with compute 1000. As illustrated in FIG. 20, the alternative data offload device 53050 may be a base 53100 containing a WPT system 54000 configured with transmitter coils 54100a, 54100b to transfer power to the robot 1 via inductive receiver coils in the feet 92 of the robot 1. The communication transceiver module 53400 of the alternative data offload device 53050 includes antenna array modules 53420a, 53420b spaced to couple at a predefined distance. For example, the predefined distance may be based on a distance between the left and right feet 92a, 92b when the robot 1 is standing in a neutral state. As shown in the illustrative example, the separate antenna array modules 53420a, 53420b may be arranged within the center portion of the transmitter coils 54100a, 54100b so that when the robot 1 centers its feet 92 for charging, the antenna array modules 53420 of the communication transceiver modules 50604.3400, 53400.3400 are aligned. In another example, the alternative data offload device 53050 may omit the WPT system 54000 from the base 53100. In some embodiments, the antenna array modules 53420a, 53420b in the feet 92 may be shielded from the electromagnetic fields generated by the transmitter coils 54100a, 54100b by means of an intervening ferrite layer or a conductive ground plane, thereby preventing interference between the wireless power transfer and the millimeter-wave data link.

### G. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. Further, “minor” means a deviation of less than 25% and preferably less than 15%. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, and 19/252,708; and (iii) U.S. Design Patent Application Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot comprising:
a torso;
a compute housed within the torso and configured to control the operation of the humanoid robot;
a data storage communicatively coupled to the compute and configured to store data collected by the humanoid robot during operation; and
a communication transceiver module communicatively coupled to the compute, the communication transceiver module comprising:
a first antenna array module including a plurality of antenna elements configured for millimeter-wave communication; and
a second antenna array module including a plurality of antenna elements configured for millimeter-wave communication,
wherein: (i) the communication transceiver module is configured to establish a wireless data link with a corresponding communication transceiver module of an external device when the communication transceiver module and the corresponding communication transceiver module are positioned within a predefined separation gap, and (ii) the wireless data link is configured to transfer data stored in the data storage to the external device at a data transfer rate exceeding 5 gigabits per second.

2. The humanoid robot of claim 1, wherein the communication transceiver module is positioned within a waist of the humanoid robot.

3. The humanoid robot of claim 1, wherein the first antenna array module is configured with a transmit pair of antenna elements and a receive pair of antenna elements, and wherein the second antenna array module is configured with a transmit pair of antenna elements and a receive pair of antenna elements.

4. The humanoid robot of claim 3, wherein the first and second antenna array modules are arranged side by side on a printed circuit board, and wherein each antenna array module comprises four antenna elements arranged in a two-by-two grid pattern.

5. The humanoid robot of claim 1, wherein at least a portion of the humanoid robot is formed from an RF transparent material, and wherein the communication transceiver module is positioned within the humanoid robot such that radio waves pass through the portion of the humanoid robot formed from the RF transparent material.

6. The humanoid robot of claim 1, wherein the predefined separation gap is between 5 mm and 50 mm.

7. The humanoid robot of claim 1, wherein the communication transceiver module is configured to perform electronic beam-steering to adjust directionality of transmitted signals to compensate for minor misalignments between the communication transceiver module and the corresponding communication transceiver module of the external device.

8. The humanoid robot of claim 1, further comprising a behavior manager configured to constrain the humanoid robot from initiating motion relative to the external device until the wireless data link completes a data transfer protocol or the data transfer protocol is terminated.

9. A humanoid robot comprising:
a torso;
a waist coupled to the torso;
a plurality of sensors configured to collect data during operation of the humanoid robot;
a data storage configured to store the data collected by the plurality of sensors; and
a communication transceiver module coupled to the waist, the communication transceiver module: (i) comprising a plurality of antenna elements configured to emit signals at a frequency that is above 40 GHz, and (ii) configured to wirelessly offload data from the data storage to an external device when the humanoid robot is mechanically coupled to the external device.

10. The humanoid robot of claim 9, wherein the plurality of sensors comprise one or more cameras configured to continuously capture video data during operation of the humanoid robot.

11. The humanoid robot of claim 9, wherein the communication transceiver module is coupled to the waist in a rear-facing orientation.

12. The humanoid robot of claim 9, wherein the humanoid robot is configured to:
receive a communication from the external device confirming successful mechanical coupling between the humanoid robot and the external device based on sensor data collected by one or more sensors of the external device; and
based on receiving the communication from the external device, initiate the wireless offload of data via the communication transceiver module.

13. The humanoid robot of claim 9, wherein the humanoid robot further comprises left and right feet configured to receive wireless power from a wireless power transfer system of the external device, and wherein the humanoid robot is configured to simultaneously receive wireless power through the left and right feet and offload data through the communication transceiver module when mechanically coupled to the external device.

14. The humanoid robot of claim 9, wherein the data storage is configured to store data collected during an operational runtime period, and wherein the communication transceiver module is configured to offload all data collected during the operational runtime period in a time period that is less than a time period required to fully charge a battery pack of the humanoid robot following the operational runtime period.

15. The humanoid robot of claim 9, wherein the humanoid robot further comprises a near-field communication transceiver configured to perform a secure handshake with the external device prior to initiating data transfer via the communication transceiver module.

16. A humanoid robot comprising:
a plurality of sensors configured to capture sensor data during an operational runtime of the humanoid robot;
a battery pack configured to power the humanoid robot;
a data storage configured to store the sensor data collected during the operational runtime;
a wireless power receiver configured to receive wireless power from corresponding wireless power transmitter to charge the battery pack of the humanoid robot; and
a communication transceiver module including at least one antenna array module having a plurality of antenna elements configured for high data rate millimeter-wave communication,
wherein:
the communication transceiver module is configured to establish a short-range wireless data link,
sensor data captured during a given operational runtime is offloadable via the wireless data link in a data offload time period, and
the data offload time period is less than a charging time period required for the wireless power receiver to recharge an amount of energy discharged from the battery pack during the given operational runtime.

17. The humanoid robot of claim 16, wherein the communication transceiver module operates at a frequency of approximately 60 GHz and provides a data transfer rate of at least 5 gigabits per second.

18. The humanoid robot of claim 16, wherein the communication transceiver module comprises a first antenna array module positioned within a first foot of the humanoid robot and a second antenna array module positioned within a second foot of the humanoid robot.

19. The humanoid robot of claim 16, wherein the humanoid robot further comprises a waist, wherein the communication transceiver module is positioned within the waist, and wherein a docking station comprises a support cradle configured to mechanically couple with the waist of the humanoid robot, the cradle including the corresponding communication transceiver module positioned to align with the communication transceiver module of the humanoid robot when the humanoid robot is docked with the docking station.

20. The humanoid robot of claim 16, wherein the humanoid robot is configured to:
receive a communication from the docking station confirming successful docking between the humanoid robot and a docking station based on sensor data collected by one or more sensors of the docking station; and
based on receiving the communication from the docking station, initiate offload of the captured sensor data.
